(19) United States
(12) Patent Application Publication
(10) Pub. No.: US 2021/0054999 A1
(43) Pub. Date: Feb. 25, 2021

(54) THERMALLY-ACTUATED GAS VALVE WITH CERAMIC HEATER

(71) Applicant: SCP Holdings, LLC, Auburn, IN (US)

(72) Inventors: Jack A. Shindle, Leo, IN (US); Yin Liu, Fort Wayne, IN (US); Joseph L. Mark, Indianapolis, IN (US); Jacob Penland, Auburn, IN (US)

(21) Appl. No.: 16/994,888

(22) Filed: Aug. 17, 2020

Related U.S. Application Data
(60) Provisional application No. 62/888,872, filed on Aug. 19, 2019.

(51) Int. Cl. F23Q 7/24; F23N 1/00; H05B 3/16; H05B 3/12; F23Q 7/06; H05B 3/18; C04B 35/584; C04B 41/00; C04B 41/45; C04B 41/50; C04B 41/87

(52) U.S. Cl. CPC F23Q 7/24; F24C 3/128; H05B 3/16; H05B 3/12; F23Q 7/06; H05B 3/18; C04B 35/584; C04B 41/009; C04B 41/4543; C04B 41/5057; C04B 41/87; F23N 2227/02; F23N 2227/42; H05B 2203/02; F23N 1/005

(57) ABSTRACT

A thermally-actuatable gas valve assembly comprising a ceramic heater is shown and described. The gas valve assembly comprises a housing with a gas inlet and a gas outlet. A bimetal thermal actuator has a valve plug that removably seals the gas outlet from the interior of the housing. The ceramic heater is energizable to cause the thermal actuator to deflect which unseats the valve plug from the gas outlet, thereby placing the gas outlet in fluid communication with the gas inlet and the interior of the housing. A gas heating system is also shown and described in which the gas valve assembly selectively supplies cooking gas to a silicon nitride ceramic igniter. The igniter and the heater are in series such that when a source of alternating current is applied across the igniter and the heater, the igniter reaches the autoignition temperature of the combustion gas before the valve assembly opens

### CROSS-REFERENCE TO RELATED APPLICATIONS

This application claims the benefit of U.S. Provisional Application No. 62/888,872, filed on Aug. 19, 2019, the entirety of which is hereby incorporated by reference.

### FIELD

This disclosure relates to gas control valves that are thermally-actuated by a ceramic heater and to gas heating systems comprising such control valves with ceramic igniters.

### BACKGROUND

Many oven cavities in the United States and abroad are heated by gas using a ceramic igniter, such as a silicon carbide hot surface igniter. Silicon carbide ceramic igniters include a semi-conductive ceramic body with terminal ends across which a potential difference is applied. Current flowing through the ceramic body causes the body to heat up and increase in temperature, providing a source of ignition for the combustion gases. In such oven heating systems, it is standard to include a thermally-actuated gas control valve assembly, sometimes referred to as a bimetal gas valve assembly, to ensure that combustible gas is only supplied to the silicon carbide igniter once it has reached a surface temperature at which a combustible mixture of the combustion gas and air will ignite.

The gas valve assembly and the silicon carbide igniter are connected in series to the AC (nominal 120 VAC) mains through a switch or relay that controls the flow of electricity to the circuit. When the oven calls for heat the switch is closed and electricity flows to the silicon carbide igniter first and then the bimetal valve assembly. The igniter has a negative temperature coefficient of resistance and a high resistance at room temperature which limits the voltage and current to the bi-metal valve assembly. The high initial resistance prevents the valve from opening before the hot surface igniter has reached the ignition temperature of the combustion gas. As the hot surface igniter begins to heat up its resistance begins to drop (due to the negative coefficient of resistance) and eventually stabilizes at approximately 35 ohms and 2700° F. (maximum temperature) at 116 VAC.

As the resistance of the igniter drops the current begins to flow to the bimetal valve assembly. Inside the assembly are a wire resistance element and a thermally deflectable bimetal strip. The wire resistance element is wrapped around a portion of the bimetal strip and as current begins to flow, the resistance element begins to heat up. As the resistance element heats up, the bimetal strip reaches a deflection temperature at which it deflects to unseat a valve plug from the gas valve assembly's gas outlet, thereby placing the interior of the assembly and its gas inlet in fluid communication with the gas outlet and allowing gas to flow. The required voltage of 3.03-3.30 VAC and 3.2-3.6 Amps is not provided by the circuit until the silicon carbide igniter is at the desired operating temperature. The bimetal strip comprises two metals having different coefficients of expansion. The differing coefficients of expansion cause the strip to bend so the valve plug end of the bimetal strip deflects away and is unseated from the gas outlet.

The advantage of this design is that the current required to open the bimetal gas valve will not be present until the hot surface igniter is at its operating temperature. This ensures that no flow of a combustible gas is allowed until the hot surface igniter is at a temperature that will insure ignition of the gas.

Unfortunately, there are disadvantages to known thermally-actuated gas control valve assemblies and gas heating systems that utilize them in combination with silicon carbide igniters. First, silicon carbide igniters, in particular the M-circuit design, are very fragile and easily broken during installation at the factory, shipping and installation of the oven in the end users' home. In addition, silicon carbide igniters are slow to heat up and, in most cases, take 10-20 seconds to get to their desired operating temperature.

Moreover, the bimetal valve is also slow, requiring an additional 20-40 seconds to open after the silicon carbide igniter reaches its desired operating temperature. As a result, the overall time to ignition is somewhere between 30-60 seconds. Further, the silicon carbide hot surface igniter will form a silicon dioxide insulating layer on the surface of silicon carbide grains and leads, producing an increase in the room temperature resistance of the igniter over time. This increase in resistance further increases the overall time to temperature, degrading the overall performance of the system. Also, silicon carbide is a semiconductor, and the entire igniter is conductive. This requires that the operator of the oven must be protected from inadvertent contact to prevent burns or electrical shorting.

Silicon nitride igniters have long been used in water heater and furnace applications and have several advantages over silicon carbide igniters. First, silicon nitride igniters have superior strength and fracture toughness, making them very durable in their various applications. Moreover, the surface of the silicon nitride igniter is insulating so the risk of electrical shorting is eliminated. In addition, the time to temperature is 50-75% faster compared to silicon carbide, and the power draw is 80% less than silicon carbide. It is also worth noting that silicon nitride igniters have a positive temperature coefficient of resistance, like most materials.

The obstacle to the adoption of silicon nitride igniters in an oven cavity has been the expense of the control system required to turn the igniter on and off. The current drawn by the typical silicon nitride igniter is not sufficient to cause the gas valve assembly to open with typical wire resistance elements. Therefore, the bimetal valve would need to be replaced with a valve like a solenoid, and a control board would need to be added to turn the igniter on, sense when it has reached temperature and send a signal to the solenoid to open. The combination of these features makes adoption cost prohibitive. In contrast, the silicon carbide igniter in combination with the bimetal gas valve is very cost competitive. Thus, a need has arising for a gas valve assembly that addresses the foregoing.

### SUMMARY

In accordance with a first aspect of the present disclosure, a thermally-actuatable gas valve assembly is provided which comprises a housing, a thermal actuator, a valve plug, and a ceramic heater. The housing has a gas inlet, a gas outlet, and an interior volume that is in selective fluid communication with the gas outlet. A thermal actuator is disposed in the interior volume, and the valve plug is operatively connected to the thermal actuator. The valve plug is positioned to selectively seal the gas outlet from the interior volume, and the ceramic heater is in thermal communication with the thermal actuator. In certain examples, the thermal actuator comprises a bimetal member or bimetal member assembly that deflects when heated to a deflection temperature. In the same or other examples, the ceramic heater comprises a ceramic body and a conductive ink pattern disposed in the ceramic body. In the same or other examples, the ceramic body comprises silicon nitride. At the same time or in other examples, the ceramic heater's conductive ink pattern has a room temperature resistivity of from about 6.5×10⁻⁵ Ω·cm to about 2×10⁻⁴ Ω·cm. At the same time or in other examples, the conductive ink pattern has a room temperature resistance of from about 5Ω, to about 15Ω.

In accordance with a second aspect of the present disclosure, a gas heating system is provided which comprises a ceramic igniter and a thermally-actuated gas valve assembly comprising a housing, a thermal actuator, a valve plug, and a ceramic heater. The housing has a gas inlet, a gas outlet, and an interior volume that is in selective fluid communication with the gas outlet. A thermal actuator is disposed in the interior volume, and the valve plug is operatively connected to the thermal actuator. The valve plug is positioned to selectively seal the gas outlet from the interior volume of the gas valve assembly, and the ceramic heater is in thermal communication with the thermal actuator. In certain examples, the thermal actuator comprises a bimetal member or bimetal member assembly that deflects when heated to a deflection temperature. In certain examples, the ratio of the ceramic igniter's room temperature resistance to the ceramic heater's room temperature resistance is from about 1.9 to about 4.0. At the same time, the sum of the ceramic igniter's room temperature resistance and the ceramic is from about 25Ω to about 65Ω.

In accordance with a third aspect of the present disclosure, a gas heating system is provided which comprises a ceramic igniter comprising a conductive ink pattern having a positive temperature coefficient of resistivity and a thermally-actuated gas valve assembly. The thermally-actuated gas valve assembly comprises: i) a housing having a gas inlet, a gas outlet, and an interior volume that is in selective fluid communication with the gas outlet; (ii) a thermal actuator disposed in the interior volume; (iii) a valve plug operatively connected to the thermal actuator and positioned to selectively seal the gas outlet from the interior volume; and (iv) a heater in thermal communication with the thermal actuator. In certain examples, the heater is a ceramic heater comprising a conductive ink pattern. At the same time or in other examples, the ceramic heater has a positive temperature coefficient of resistivity.

In accordance with a fourth aspect of the present disclosure, a method of igniting gas is provided. The method comprises providing a source of combustion gas in selective fluid communication with a ceramic igniter, providing a gas valve assembly operable to selectively place the source of combustion gas in fluid communication with the ceramic igniter, energizing the ceramic igniter such that it reaches a surface temperature of no less than an ignition temperature of the combustion gas, and energizing the ceramic heater to place the source of combustion gas in fluid communication with the ceramic igniter. The gas valve assembly comprises a thermal actuator and a ceramic heater in thermal communication with the thermal actuator. In certain examples, the thermal actuator is a deflectable member, and the step of energizing the ceramic heater to place the source of combustion gas in fluid communication with the ceramic igniter comprises heating the thermal actuator such it deflects. At the same time or in other examples, the ratio of the ceramic igniter room temperature resistance to the ceramic heater room temperature resistance is from about 1.9 to about 4.0. At the same time or in other examples, the sum of the room temperature resistance of the ceramic igniter and the room temperature resistance of the ceramic heater is from about 25Ω to about 65Ω. At the same time or in other examples, the step of energizing the ceramic heater comprises applying a potential difference of at least about 15V AC rms across the ceramic heater. At the same time or in other examples, the step of energizing the ceramic igniter comprises applying a potential difference of at least about 75V AC rms across it. At the same time or in other examples, the gas valve assembly comprises a gas inlet and a gas outlet, the thermal actuator is fixed at one end relative to a ceramic insulator in the gas valve assembly and has a free end connected to a valve plug, and the valve plug is removably seated in the gas outlet, such that when the thermal actuator deflects, the valve plug becomes unseated from the gas outlet to place the gas inlet in fluid communication with the gas outlet. At the same time or in other examples, the gas inlet is placed in fluid communication with the gas outlet no sooner than when the ceramic igniter reaches an autoignition temperature of the combustion gas.

### BRIEF DESCRIPTION OF THE DRAWINGS

FIG. 1A is top perspective, exploded view of a prior art, thermally-actuated gas valve assembly;

FIG. 1B is a bottom perspective, exploded view of the prior art gas valve assembly of FIG. 1A;

FIG. 1C is a cross-sectional view of the gas valve assembly of FIG. 1A in a first configuration in which the gas inlet is not in fluid communication with the gas outlet;

FIG. 1D is a cross-sectional view of the gas valve assembly of FIG. 1C in which the gas inlet is in fluid communication with the gas outlet;

FIG. 2 is a circuit diagram with a ceramic igniter and ceramic heater in series with each other and a source of alternating current;

FIG. 3A is a top perspective view of a first embodiment of a thermally-actuatable gas valve assembly comprising a ceramic heater with the housing removed;

FIG. 3B is a bottom perspective view of the gas valve assembly of FIG. 3A;

FIG. 4A is a top perspective view of a second embodiment of a thermally-actuatable gas valve assembly comprising a ceramic heater with the housing removed;

FIG. 4B is a bottom perspective view of the gas valve assembly of FIG. 4A;

FIG. 5A is a bottom perspective view of a third embodiment of a thermally-actuatable gas valve assembly comprising a ceramic heater with the housing removed;

FIG. 5B is a top plan view of the gas valve assembly of FIG. 5A;

FIG. 6A is a top perspective view of a fourth embodiment of a thermally-actuatable gas valve assembly comprising a ceramic heater with the housing removed;

FIG. 6B is a bottom perspective view of the gas valve assembly of FIG. 6A;

FIG. 7A is a graph of the potential differences across a ceramic igniter and ceramic heater which have comparable resistances and which are in series with one another versus the circuit input voltage;

FIG. 7B is a graph of the potential differences across a ceramic igniter and ceramic heater in series with one another versus input voltage wherein the ceramic heater resistance is significantly lower than the ceramic igniter resistance;

FIG. 8 is a graph of the potential differences across and power drawn by a ceramic igniter and ceramic heater in series with one another versus the circuit input voltage wherein the ceramic heater and ceramic igniter have a first ratio of room temperature resistances;

FIG. 9 is a graph of the potential differences across and power drawn by a ceramic igniter and ceramic heater in series with one another versus the circuit input voltage wherein the ceramic heater and ceramic igniter have a second ratio of room temperature resistances;

FIG. 10 is a graph of the potential differences across and power drawn by a ceramic igniter and ceramic heater in series with one another versus the circuit input voltage wherein the ceramic heater and ceramic igniter have a third ratio of room temperature resistances;

FIG. 11 is a graph of the potential differences across and power drawn by a ceramic igniter and ceramic heater in series with one another versus the circuit input voltage wherein the ceramic heater and ceramic igniter have a fourth ratio of room temperature resistances; and

FIG. 12 is a depiction of the circuit used to generate the graphs of FIGS. 7A-11.

Like reference numerals refer to like parts in the figures.

### DESCRIPTION

Described below are examples of thermally-actuated gas valve assemblies comprising a ceramic heater and gas heating systems comprising such gas valve assemblies and ceramic igniters. The gas valve assemblies include a thermal actuator that deflects when subjected to a deflection temperature, thereby unseating a valve plug from an outlet port of the gas valve assembly and placing the outlet port in fluid communication with the inlet port. In certain examples, the ceramic igniter is a silicon nitride igniter. In the same or other examples, the ceramic heater is a silicon nitride heater. As compared to known gas valve assemblies, those described herein are more resistant to fracture and ignite combustion gas more quickly.

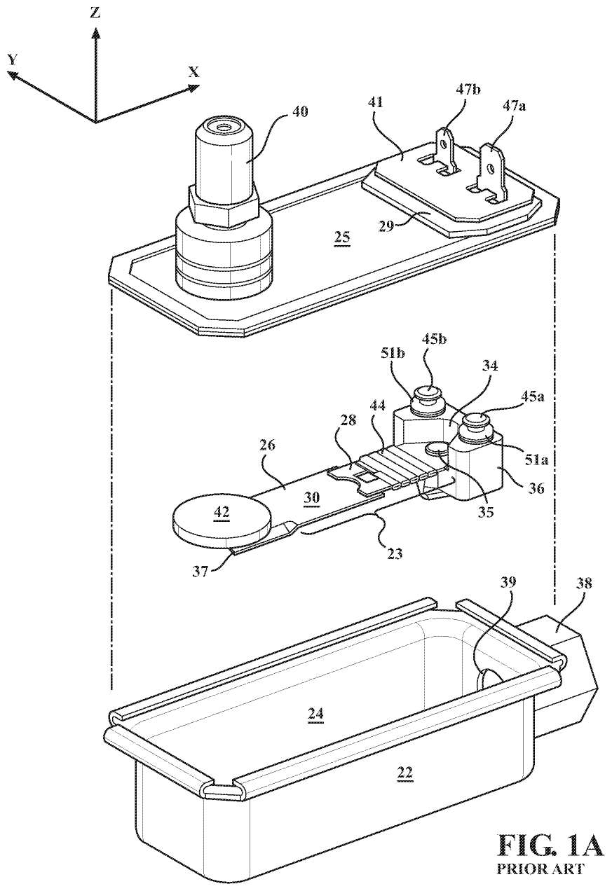

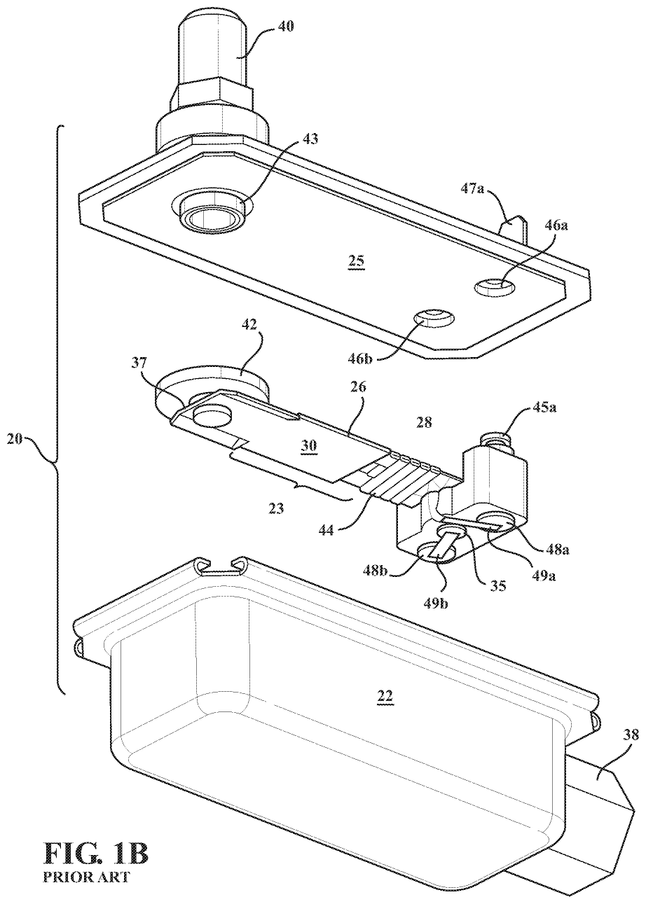

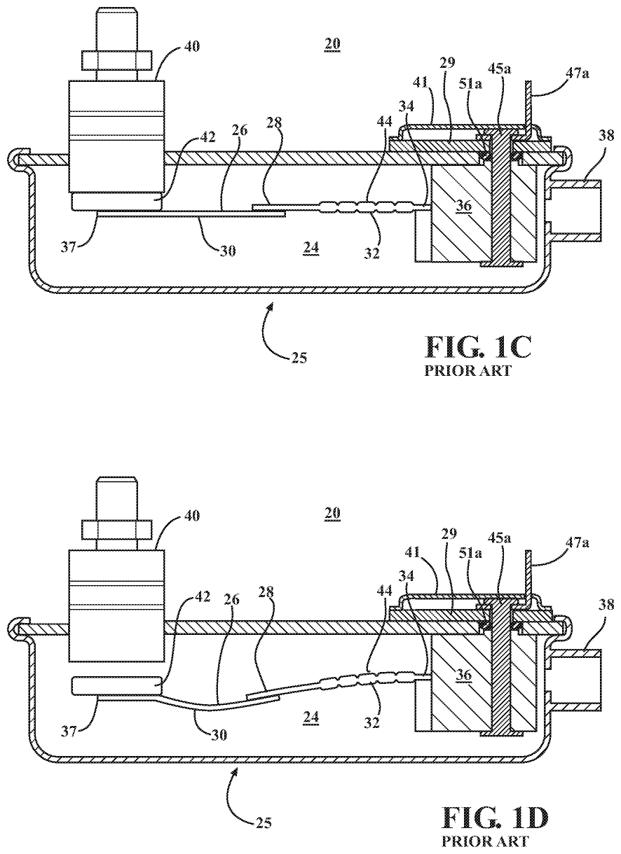

Referring to FIG. 1A, a prior art gas valve assembly 20 is shown. The gas valve assembly 20 comprises a housing 22 and a top 25 that fits over the housing 22 to define an enclosed interior 24. The enclosed interior 24 contains a volume of combustible gas. Gas inlet port 38 admits gas from a gas source (not shown) to enclosed interior 24. Gas outlet port 40 is connected to a burner (not shown). A silicon carbide igniter (not shown) is in fluid communication with the burner to ignite combustion gas selectively provided by gas valve assembly 20.

A thermal actuator 26 is attached to a valve plug 42 that selectively and sealingly engages the inlet 43 of gas outlet port 40. When valve plug 42 sealingly engages inlet 43, the gas outlet port 40 is not in fluid communication with the gas inlet port 38 of the gas valve assembly 20 or the interior 24 of the housing 22 of the gas valve assembly 20, in which case combustible gas will not flow from gas valve assembly 20 to the burner to which the gas outlet port 40 is connected.

The thermal actuator 26 preferably deflects in response to heat to move the valve plug 42 in and out of engagement with the inlet 43 of gas outlet port 40. In certain preferred examples, thermal actuator 26 comprises a bimetal member assembly 23 formed from two metals having different coefficients of thermal expansion. In the example of FIGS. 1A and 1B, the bimetal member assembly 23 comprises two bimetal members 28 and 30, each of which comprises two metals having different coefficients of thermal expansion. The two metals are adjacent one another along the z-axis.

The bimetal member assembly 23 has a first end 34 and a second end 37 spaced apart from one another along the x-axis. The bimetal member assembly 23 is cantilevered. First end 34 is fixedly attached to insulator block 36 via rivet 35. Insulator block 36 is fixedly attached to the interior of housing 22. Second end 37 is attached to valve plug 42 which is not fixedly attached to the housing, either directly or indirectly. When the bimetal member assembly 23 is heated to a deflection temperature, the second end 37 moves away from inlet 43 of gas outlet port 40 in a direction along the z-axis to unseat valve plug 42 from the gas inlet 43 of gas outlet port 40 and provide combustible gas to the burner(s) to which gas outlet port 40 is connected.

First bimetal member 28 is attached to insulator block 36 at a first end 34 and to a second bimetal member 30 at a second end 39. The first bimetal member 28 is attached to and overlaps second bimetal member 30 in a direction along the x-axis. A wire resistance heater 44 is provided along and wraps around first bimetal member 28 and is selectively energizable to heat the bimetal member assembly 23 to a temperature above the deflection temperature (the temperature at which the bimetal member assembly 23 deflects sufficiently to unseat valve plug 42 from gas inlet 43 of gas outlet port 40). In one known example, the wire resistance heater 44 comprises a nickel-chromium alloy coil wrapped around at least a portion of the first bimetal member 28 and extending along at least a portion of the member's 28 length along the x-axis.

Insulator block 36 preferably comprises a ceramic material and includes two rivets (not separately identified) having upper rivet heads 45a and 45b used to place the wire resistance heater 44 in an electric circuit and in electrical communication with a source of alternating current. Each of the two rivets extends through the insulator block 36 along the z-axis direction. The upper rivet heads 45a and 45b are disposed on the ends of respective rivets which extend through insulator block 36 and through respective silicone o-ring seals 51a and 51b. Underneath the insulator block (FIG. 1B), lower rivet heads 48a and 48b are electrically conductive as are their corresponding upper rivet heads 45a and 45b. When cover 25 engages housing 22, the upper rivet heads 45a and 45b are seated in openings 46a and 46b (FIG. 1B) and project through a mica insulator 29 such that they are in electrical communication with corresponding conductive prongs 47a and 47b. Prongs 47a and 47b are plugged into a source of alternating current that preferably ranges from about 102 VAC rms to 132 VAC rms. Plastic insulator 42 covers the upper rivet heads 45a and 45b.

Referring again to FIG. 1B, wire resistance heater 44 is electrically connected to lower rivet head 48a via electrical connector 49a, which may be, for example, a resistance weld or a portion of wire resistance heater 44 which may be extended to the lower rivet head 48a and then resistance welded to the lower rivet head 48a. The connection from wire resistance heater 44 to lower rivet head 48b is a ground connection and is not visible in FIG. 1B. However, as shown in FIG. 1B, central rivet 35 is grounded by electrically connecting it to rivet 48b via connector 49b, which may be, for example, a resistance weld or a metal strip connected to rivet 33 and lower rivet head 48b.

Referring to FIGS. 1C and 1D, gas valve assembly 20 is shown in a first operative configuration (FIG. 1C) in which the gas outlet port 40 is not in fluid communication with the interior volume 24 of the housing 22 or the gas inlet port 38. In this configuration, combustible gas is not supplied from the gas valve assembly 20 to a burner to which the gas outlet port 40 is connected. The bimetal member assembly 23 is in an undeflected configuration, and valve plug 42 sealingly engages gas inlet 43 of gas outlet port 40. In this first configuration, the wire resistance heater 44 has not heated bimetal member assembly 23 to a deflection temperature.

In the second operative configuration (FIG. 1D), wire resistance heater 44 has been selectively energized such as by placing it in series with a source of alternating current and with a silicon carbide igniter. As a result, the bimetal member assembly 23 has been heated to a temperature beyond a minimum deflection temperature. Because of the cantilevered connection between bimetal member assembly 23 and insulator block 36, the first bimetal member 28 bends downward along the z-axis, thereby applying a downward (z-axis) force to second bimetal member 30. In addition, second bimetal member 30 also deflects relative to first bimetal member 28 to unseat the valve plug 42 from the gas inlet 43 of gas outlet port 40. In the second configuration of FIG. 1D, the gas inlet port 38 is in fluid communication with gas outlet port 40 and the interior 24 of housing 22. As a result, combustible gas will flow from gas inlet port 38 through gas outlet port 40 and to a burner to which gas outlet port 40 is connected.

The prior art gas valve assembly 20 of FIGS. 1A-1D is used with a ceramic igniter having a positive temperature coefficient of resistance, namely, a silicon carbide igniter, to define a gas heating system. In certain examples of known, thermally-actuatable gas valve assemblies 20 used for oven cavities, the wire resistance heater 44 must be provided with a potential difference of 3.03 to 3.30 VAC (rms) and an rms alternating current of 3.2-3.6 Amps to cause the thermal actuator 26 to deflect and unseat the valve plug 42 from the gas inlet 43 of gas outlet port 40. In such cases, the silicon carbide igniter reaches the ignition temperature of the combustible gas before the thermal actuation member 26 unseats the valve plug 42 from the gas inlet 43 of the gas outlet port 40, thereby preventing the flow of unignited combustion gas into the burner.

In accordance with the present disclosure, a thermally-actuatable gas valve assembly is used with a silicon nitride igniter. Unlike a silicon carbide igniter, silicon nitride igniters have a positive temperature coefficient of resistance. If placed in series with a wire resistance heater of the type found in currently available thermally-actuated gas control valves and a source of 120 VAC (rms) current, the valve plug 42 will never unseat from the gas inlet 43 of the gas outlet port 40 because the current draw will be too low. Known wire resistance heaters would have to be extended in length significantly and impractically to provide sufficient heat to deflect the bimetal member assembly 23.

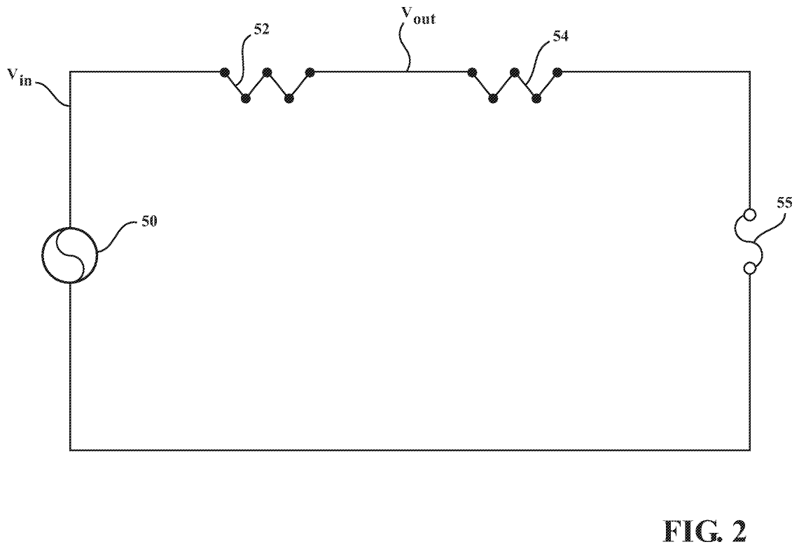

It has been discovered that a ceramic heater may be used in place of a wire resistance heater to generate sufficient heat to unseat the valve plug 42 from the gas outlet port 40 and supply combustible gas from the valve assembly to a fluidly coupled burner. In accordance with an embodiment, a silicon nitride igniter 52 is provided and placed in series with a source of alternating current 50 and the ceramic heater 54 as shown in FIG. 2. The source of alternating current preferably has an rms AC voltage of from 102 V to 132V. The resistances of the igniter 52 and the heater 54 are preferably selected such that the igniter 52 reaches the autoignition temperature of the gas before the heater 54 reaches a minimum deflection temperature of the bimetal member or members used to define a thermal actuator (the “minimum deflection temperature” being the lowest temperature that can unseat valve 72 from gas outlet port 40). Fuse 55 is also provided to open the circuit if the current reaches a level at which the thermal actuator in ceramic heater 54 may overheat and exceed its maximum deflection temperature. Current thermally-actuatable gas valve assemblies and silicon carbide igniters cannot be used with a fuse because the voltage available to actuate the gas valve would be insufficient to open the valve if a fuse were added. Although not shown in the figure, a switch may be provided to allow users to selectively energize the ceramic igniter 52 and the ceramic heater 54.

Ceramic igniters useful in connection with the gas valve assemblies described herein include those described in U.S. patent application Ser. No. 16/366,479, the entirety of which is hereby incorporated by reference.

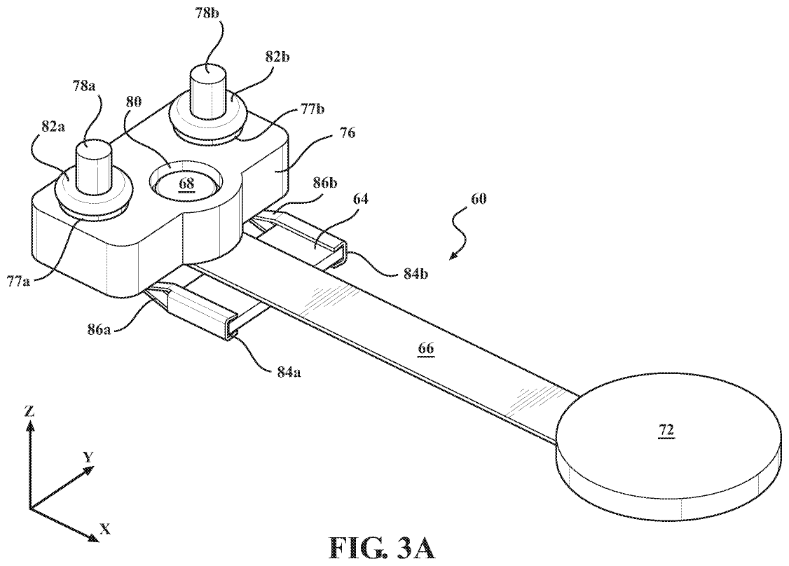

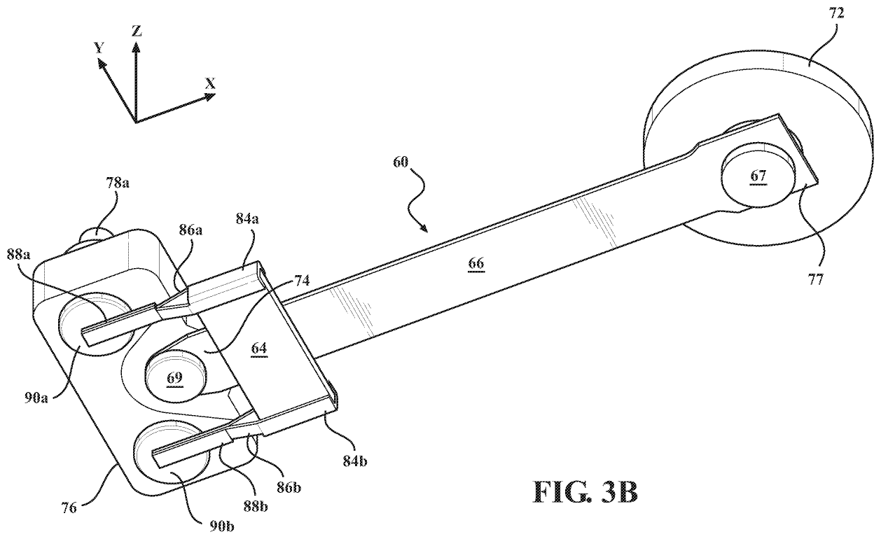

Although represented as a resistor 52 in FIG. 2, ceramic igniters useful in the gas heating systems described herein comprise a hot surface igniter having a ceramic body with a length defining a length axis, a width defining a width axis, and a thickness defining a thickness axis. The igniter comprises first and second ceramic tiles having respective outer surfaces. A conductive ink pattern is disposed between the first and second ceramic tiles. The igniter has a thickness along the thickness axis of from about 0.047 inches to about 0.060 inches, preferably from about 0.050 to about 0.058 inches, and more preferably from about 0.052 inches to about 0.054 inches. See FIGS. 3A-3H and corresponding text of U.S. patent application Ser. No. 16/366,479.

The ceramic igniters described herein are generally in the shape of a rectangular cube and include two major facets, two minor facets, a top and a bottom. The major facets are defined by the first (length) and second (width) longest dimensions of the ceramic igniter body. The minor facets are defined by the first (length) and third (thickness) longest dimensions of the igniter body. The igniter bodies also include a top surface and a bottom surface which are defined by the second (width) and third (thickness) longest dimensions of the igniter body.

The igniter tiles are ceramic and preferably comprise silicon nitride. The conductive ink circuit is disposed between the tiles and generates heat when energized. The ceramic tiles are electrically insulating but sufficiently thermally conductive to reach the outer surface temperature necessary to ignite combustible gases such as natural gas, propane, butane, and butane 1400 (a butane and air mixture with a heating value of 1400 Btu/ft³) within the desired period of time.

As described in greater detail below, in certain examples, the ceramic tiles comprise silicon nitride, ytterbium oxide, and molybdenum disilicide. In the same or other examples, the conductive ink circuit comprises tungsten carbide, and in certain specific implementations, the conductive ink additionally comprises ytterbium oxide, silicon nitride, and silicon carbide.

In certain examples, when subjected to a potential difference of 120V AC, the ceramic igniters described herein reach a surface temperature of at least 1400° F., preferably no less than 1800° F., more preferably no less than 2100° F., and even more preferably no less than 2130° F. These temperatures are preferably reached in no more than eight seconds, more preferably reached in no more than six seconds, and still more preferably, reached in no more than four seconds after the potential difference is applied.

In the same or additional examples, the surface temperature of the ceramic igniters herein does not exceed 2600° F., preferably does not exceed 2550° F., more preferably does not exceed 2500° F., and still more preferably 2450° F. at any time after a full wave 132V AC potential difference is applied, including after a steady-state temperature is reached.

In the same or other examples of ceramic igniters in accordance with the present disclosure, when subjected to a potential difference of 102V AC, the ceramic igniters described herein reach a surface temperature of at least 1400° F., preferably at least 1800° F., and still more preferably at least 2100° F. in no more than seventeen, preferably more than ten, and more preferably no more than about seven seconds after the 102V AC potential difference is first applied. These temperatures are preferably reached in no more than four seconds and are more preferably reached in no more than three seconds.

In the same or additional examples, the thickness of the conductive ink circuit of the hot surface igniter (taken along the thickness axis) is not more than about 0.002 inches, preferably not more than about 0.0015 inches, and more preferably, not more than about 0.0009 inches. In the same or additional examples, the thickness of the conductive ink circuit (taken along the thickness axis) is not less than about 0.00035 inches, preferably not less than about 0.0003 inches, and more preferably, no less than about 0.0004 inches.

The hot surface igniters of the present disclosure also preferably have a green body density of at least 50 percent of theoretical density, more preferably, at least 55 percent, and still more preferably at least 60 percent of theoretical density.

As discussed in U.S. patent application Ser. No. 16/366,479, ceramic igniters used in the gas heating systems described herein are prepared by sintering ceramic compositions. Post-sintering, the tiles used to form the igniter 52 (not including conductive ink circuit) have a room temperature resistivity that is no less than 10¹² Ω-cm, preferably no less than 10¹³ Ω-cm, and more preferably, no less than 10¹⁴ Ω-cm. In the same or other examples, the tiles and have a thermal shock value in accordance with ASTM C-1525 of no less than 900° F., preferably no less than 950° F., and more preferably, no less than 1000° F.

The conductive ink comprising the conductive ink circuit has a (post-sintering) room temperature resistivity of from about 1.4×10⁻⁴ Ω·cm to about 4.5×10⁻⁴ Ω·cm, preferably from about 1.8×10⁻⁴ Ω·cm to about 4.1×10⁻⁴ Ω·cm, and more preferably from about 2.2×10⁻⁴ Ω·cm to about 3.7×10⁻⁴ Ω·cm. In the case of a material with a constant cross-sectional area along its length, resistivity p at a given temperature T is related to resistance R at the same temperature Tin accordance with the well-known formula:

R(T)=ρ(T)(l/A), where (1)
ρ=resistivity of conductive circuit material (Ω-cm) at temperature T;
R=Resistance in ohms (Ω) at temperature T;
T=Temperature (° F. or ° C.);
A=cross-sectional area (cm²) of conductive ink circuit perpendicular to the direction of current flow; and
l=total length (cm) of the conductive ink circuit along the direction of current flow.

In the case of a cross-sectional area that varies along the length of the conductive circuit, the resistance may be represented as:

$$R = ρ ( T ) {\int }_{0}^{L} \frac{d l}{A} \qquad ( 2 )$$

where, L=total length of circuit along direction of current flow, and the remaining variables are as defined for equation (1).

The ceramic bodies comprising the ceramic igniters herein preferably comprise silicon nitride and a rare earth oxide sintering aid, wherein the rare earth element is one or more of ytterbium, yttrium, scandium, and lanthanum. The sintering aids may be provided as co-dopants selected from the foregoing rare earth oxides and one or more of silica, alumina, and magnesia. A sintering aid protective agent is also preferably included which also enhances densification. A preferred sintering aid protective agent is molybdenum disilicide. The rare earth oxide sintering aid (with or without the co-dopant) is preferably present in an amount ranging from about 2 to about 15 percent by weight of the ceramic body, more preferably from about 8 to about 14 percent by weight, and still more preferably from about 12 to about 14 percent by weight. Molybdenum disilicide is preferably present in an amount ranging from about 3 to about 7 percent, more preferably from about 4 to about 7 percent, and still more preferably from about 5.5 to about 6.5 percent by weight of the ceramic body. The balance is silicon nitride.

The conductive ink circuit is preferably printed onto the face of one of ceramic tiles to yield a ceramic igniter (post-sintering) room temperature resistance (RTR) of from about 20Ω to about 60Ω, preferably from about 25Ω to about 55Ω, and more preferably from about 30Ω to about 50Ω. At the same time, the ceramic igniter high temperature resistance (HTR) over the temperature range 2138° F. to 2700° F. is preferably from about 115Ω to about 280Ω, preferably from about 120Ω to about 270Ω, and more preferably from about 128Ω to about 260Ω.

The conductive ink in the igniter should comprise tungsten carbide in an amount ranging from about 20 to about 80 percent, preferably from about 30 percent to about 80 percent, and more preferably from about 70 to about 75 percent by weight of the ink. Silicon nitride is preferably provided in an amount ranging from about 15 to about 40 percent, preferably from about 15 to about 30 percent, and more preferably from about 18 to about 25 percent by weight of the ink. The same sintering aids or co-dopants described for the ceramic body are also preferably included in an amount ranging from about 0.02 to about 6 percent, preferably from about 1 to about 5 percent, and more preferably from about 2 to about 4 percent by weight of the ink.

The ceramic heaters 54 (FIG. 2) of the present application are constructed in generally the same manner as the ceramic igniters. However, to ensure that the ceramic igniter 52 reaches the ignition temperature of the combustible gas, the igniter's 52 room temperature resistance is preferably significantly higher than that of the ceramic heater 54. The total room temperature resistance of the ceramic igniter 52 and the ceramic heater 54 is also important in determining whether the igniter will reach the combustible gas autoignition temperature and whether the ceramic heater will reach the deflection temperature of the thermal actuator 56. The ratio of the room temperature resistance of the ceramic igniters herein to the room temperature resistance of the ceramic heaters herein is preferably from about 1.9 to about 4.0, more preferably from about 2.0 to about 3.8, and still more preferably from about 2.2 to about 3.6. At the same time, the ratio of the high temperature resistance of the ceramic igniters herein to the high temperature resistance of the ceramic heaters herein over the temperature range 2138° F. to 2700° F. is from about 1.9 to about 8.0, preferably from about 2.2 to about 7.8, and more preferably from about 2.5 to about 7.3. At the same time, the sum of the room temperature resistances of the ceramic igniter 52 and the ceramic heater 54 is preferably from about 25Ω to about 60Ω, more preferably from about 30Ω to about 60Ω, and still more preferably from about 35Ω to about 55Ω, and the sum of the high temperature resistances of the ceramic heaters and the ceramic igniters herein over the temperature range 2138° F. to 2700° F. is from about 145Ω to about 288Ω, preferably from about 150Ω to about 280Ω, and more preferably from about 170Ω to about 260Ω.

Examples of thermally-actuatable gas valve assemblies in accordance with the present disclosure will now be described with reference to FIGS. 3A-6B. Each of the thermally-actuatable gas valve assemblies is structured and operates similarly to the one shown in FIGS. 1A-1D except that it uses a ceramic heater instead of a wire resistance heater to thermally actuate the valve. Referring to FIGS. 3A and 3B, a first example of a gas valve assembly 60 in accordance with the present disclosure is depicted. The housing 22 and cover 25 (FIGS. 1A-1D) are not shown in FIGS. 3A and 3B. However, they would be substantially similar in the present example. A thermal actuator 66 comprising a bimetal member is provided and is connected at a first end 74 (FIG. 3B) to insulator block 76 and at a second end 77 to valve plug 72. Bimetal member 66 comprises a high coefficient of thermal expansion material and a low coefficient of thermal expansion material, with the low coefficient of thermal expansion material being on the bottom side of bimetal member 66 (facing the ceramic heater 64), and the high coefficient of thermal expansion material being on the upper surface of the bimetal member 66 (in a direction away from the ceramic heater 64 along the z-axis) facing cover 25. This orientation of high and low coefficient of thermal expansion materials causes bimetal member to bend such that the bottom surface of bimetal member 66 (the surface facing the heater 64) is concave when viewed upward along the z-axis (as in FIG. 3B).

Valve plug 72 and connector 67 define an integrally formed elastomeric structure that is resistant to high temperatures. Valve plug 72 is connected to bimetal member 66 at bimetal member second end 77, with connector 67 being inserted through a hole (not shown) at second end 77 of bimetal member 66 to connect second end 77 to valve plug 72. Rivet 69 connects first end 74 of the thermal actuator 66 to insulator block 76. Rivet head 68 (FIG. 3A) of rivet 69 is seated in an opening 80 in an upper surface of insulator block 76. The first and second ends 74 and 77 of thermal actuator 66 are spaced apart along the length (x) axis, and the actuator 66 has a width along the y-axis and a thickness along the z-axis.

Ceramic heater 64 is preferably similar to the silicon nitride hot surface igniters described in U.S. patent application Ser. No. 16/366,479 and made in accordance with the methods and techniques described therein. Ceramic heater 64 is provided proximate first end 74 of the thermal actuator 66 and is spaced apart from the thermal actuator 66 along the z-axis such that thermal actuator 66 is between the top 25 (FIG. 1A) and the ceramic heater 64 along the z-axis. The z-axis spacing is preferably large enough to avoid contact between the thermal actuator 66 and the ceramic heater 64 when the thermal actuator 66 deflects along the z-axis to allow gas to pass through gas outlet port 40 (FIGS. 1A-1D). Ceramic heater 64 is preferably a silicon nitride heater comprised of two insulating ceramic tiles with a conductive ink circuit printed on one surface of one of the tiles and sandwiched between the tiles. Ceramic heater 64 has a length along the y-axis and a width along the x-axis, as well as a thickness along the z-axis. The length is greater than the width, and the width is greater than the thickness. Connectors 84a and 84b are brazed onto opposite ends of the ceramic heater 64 along the y-axis and place the conductive ink circuit in electrical communication with a respective one of the terminal posts 78a and 78b (formed from respective rivets), which connect to the prongs 47a and 47b on the gas valve assembly cover 25 FIG. 1A). Forked portion 86a and 86b (FIG. 3B) connects each connector 84a and 84b to a terminal 88a and 88b, each of which is electrically connected to one of the rivets 90a and 90b. Rivets 90a and 90b are formed from a conductive metal and extend along the z-axis through insulator block 76. Rivet 69 secures thermal actuator 66 to insulator block 76. Terminal posts 78a and 78b extend away from insulator block 76 along the z-axis and extend through respective silicone o-ring seals 82a and 82b and extend into cover 25 via openings 46a and 46b on the underside thereof to electrically connect to electrically conductive prongs 47a and 47b as described previously with respect to FIGS. 1A and 1B.

Bimetal member 66 is preferably located inboard of the y-axis ends of ceramic heater 64 along the y-axis by a margin sufficient to ensure that connectors 84a and 84b do not short circuit with bimetal member 66. Ceramic heater 64 has a length along the y-axis of from about 0.4 inch to about 1.0 inch, preferably from about 0.5 inch to about 0.8 inch, and more preferably from about 0.55 inch to about 0.75 inch. Ceramic heater 64 has a width along the x-axis of from about 0.15 inch to about 0.35 inch, preferably from about 0.18 inch to about 0.30 inch, and more preferably from about 0.24 inch to about 0.26 inch and a thickness along the z-axis of from about 0.030 inch to about 0.08 inch, preferably from about 0.040 inch to about 0.070 inch, and more preferably from about 0.05 inch to about 0.06 inch.

Ceramic heater 64 preferably comprises ceramic tiles that define a ceramic body with a conductive ink embedded therein. The ceramic body comprises at least one selected from a nitride ceramic, a carbide ceramic, and an oxide ceramic. Preferred carbide ceramics include silicon carbide, titanium carbide, and tantalum carbide. Preferred oxides are selected from the group consisting of alumina and cordierite. Preferred nitrides include silicon nitride and aluminum nitride. Ceramic heater 64 preferably has a positive temperature coefficient of resistance and a positive temperature coefficient of resistivity.

The conductive ink pattern between the ceramic tiles comprising the ceramic heater 64 preferably has a pre-firing thickness of from about 0.0002 inch to about 0.003 inch, more preferably from about 0.0003 inch to about 0.0025 inch, and still more preferably from about 0.0004 inch to about 0.002 inch before sintering. The ink comprising the conductive ink pattern comprises silicon nitride in an amount no greater than about 30 percent by weight of the conductive ink, and at least one conductive component in an amount no less than about 70 percent by weight of the conductive ink, wherein the conductive component is selected from the group consisting of tungsten, tungsten carbide, molybdenum, molybdenum disilicide, and titanium nitride.

Sintering aids may also be used in an amount that is no greater than about 8 percent by weight of the conductive ink, preferably no greater than about 7 percent by weight of the conductive ink, and still more preferably no greater than about 6 percent by weight of the conductive ink. In the same or other examples, sintering aids may be present in an amount of at least about 0.01 percent by weight of the conductive ink. Suitable sintering aids are selected from the group consisting of oxides, metals, and rare earth oxides. Suitable oxides include Y₂O₃, MgO, Al₂O₃, and SiO₂). Suitable metals include Ni, Co, Cu, Pd, Ru, and Rh. Suitable rare earth oxides include Yb, Sc, La, and Hf. The conductive ink of the ceramic heater 54 has a post-sintering room temperature resistivity of from about 6.5×10⁻⁵ Ω·cm to about 2×10⁻⁴ Ω·cm, preferably 8.0×10⁻⁵ Ω·cm to about 1.8×10⁻⁴ Ω·cm, and more preferably from about 1.0×10⁻⁴ Ω·cm to about 1.2×10⁻⁴ Ω·cm. The conductive ink has a room temperature resistance of from about 5Ω to about 15Ω, preferably from about 6Ω to about 11Ω, and more preferably from about 8Ω to about 10Ω. The high temperature resistance at steady state (i.e., at a temperature of 2138° F. to about 2700° F.) is from about 17Ω to about 28Ω, preferably from about 19Ω to about 26Ω, and more preferably from about 23Ω to about 25Ω. The conductive ink pattern is selected to achieve the desired resistance in light of the resistivity of the ink.

In the example of FIGS. 3A and 3B, the thermal actuator is preferably a single, bimetal member 66 comprised of two metals having differing coefficients of thermal expansion. Details of various bimetal materials that are suitable for deflecting when subjected to deflection temperatures are provided in the “Thermostatic Bimetal Designer's Guide,” distributed by Engineered Materials Solutions”, which is hereby incorporated by reference in its entirety and available at https://www.emsclad.com/fileadmin/Data/Divisions/EMS/Header/Bimetal_Designers_Guide.pdf.

The bimetal member preferably has a deflection temperature of from about 150° F. to about 1000° F., preferably from about 200° F. to about 800° F., and more preferably from about 250° F. to about 750° F. When implemented in the circuit of FIG. 2, fuse 55 is rated to ensure that the current stays below a level at which the maximum deflection temperature would be exceeded.

The bimetal material is preferably selected based on the dimensions of the gas valve apparatus and the desired deflection temperature and properties. In one example, ASTM Type™ 4 bimetal may be used (ASTM D388-06). TM4 is supplied as Truflex™ E4 by Engineered Materials Solutions of Attleboro, Mass.

In one example, bimetal member 66 comprises a first metal that comprises nickel, chromium, and iron, preferably consists essentially of nickel, chromium, and iron, and more preferably consists of nickel, chromium, and iron. At the same time, bimetal member 66 comprises a second metal that comprises nickel and iron, preferably consists essentially of nickel and iron, and more preferably consists of nickel and iron. The first metal is present in an amount ranging from about 40 percent to about 60 percent by weight of the bimetallic member, preferably from about 45 percent to about 55 percent by weight of the bimetallic member, and more preferably from about 48 percent to about 52 percent by weight of the bimetallic member. In preferred examples, the first metal has a coefficient of thermal expansion greater than the second one.

In the same or other examples, bimetallic member 66 has a density of from about 0.25 lb/in³ to about 0.35 lb/in³, preferably from about 0.27 lb/in³ to about 0.33 lb/in³, and more preferably from about 0.28 lb/in³ to about 0.32 lb/in³. In the same or other examples, bimetallic member 66 has a modulus of elasticity of from about 23×10⁻⁶ psi to about 27×10⁻⁶ psi, preferably from about 24×10⁻⁶ psi to about 26.5×10⁻⁶ psi, and more preferably from about 25×10⁻⁶ psi to about 26×10⁻⁶ psi.

In the same or other examples, bimetallic member 66 has a flexivity at 100° F. to 300° F. (measured in accordance with ASTM D388-06) of from about 7.0×10⁻⁶° F.⁻¹ to about 11.0×10⁻⁶° F.⁻¹, preferably from about 7.5×10⁻⁶° F.⁻¹ to about 10.5×10⁻⁶° F.⁻¹, and more preferably from about 8.5×10⁻⁶° F.⁻¹ to about 9×10⁻⁶° F.⁻¹.

In accordance with such examples, the bimetal member 66 has a length (along the x-axis) of from about 1.0 in. to about 3.0 in., preferably from about 1.25 in. to about 2.75 in., and more preferably from about 1.5 in. to about 2.375 in. At the same time, the bimetal member 66 has a width of from about 0.200 in. to about 0.625 in. and a thickness (along the z-axis) of from about 0.012 in. to about 0.022 in., preferably from about 0.014 in. to 0.020 in., and more preferably from about 0.016 in. to about 0.018 in.

A gas heating system may be provided by placing gas outlet port 40 of gas valve assembly 60 in fluid communication with a burner and by placing a ceramic igniter 52 (FIG. 2) of the type described previously in series with ceramic heater 54 and a source of alternating current. The source of alternating current preferably has an AC rms voltage of no less than 102V and no more than 132V. An exemplary electrical circuit for such a system is provided in FIG. 2, as discussed previously.

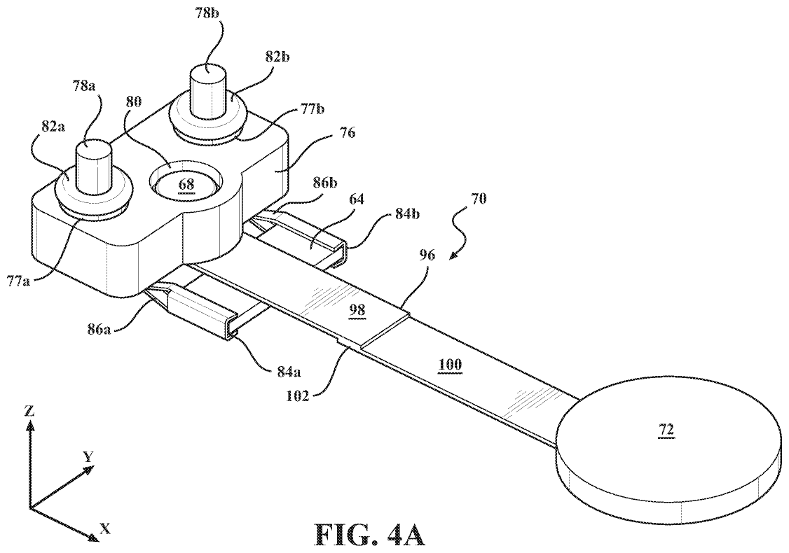

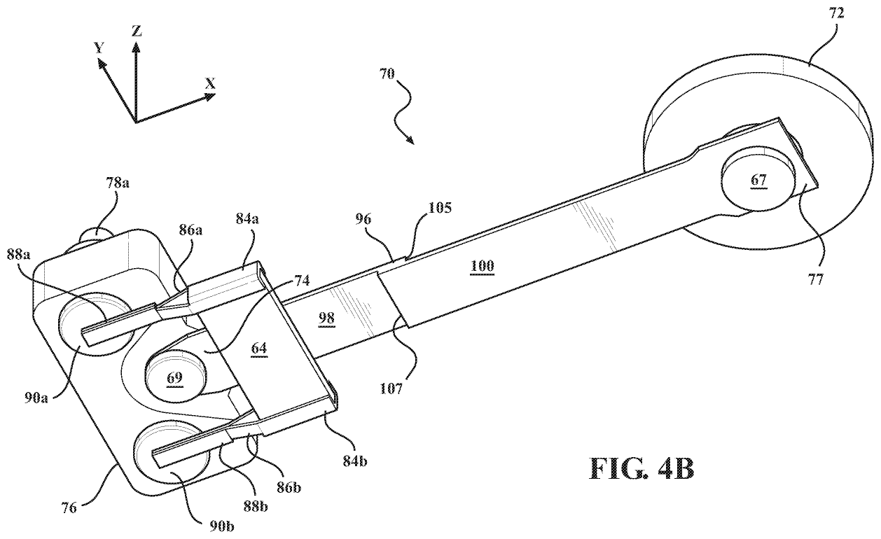

A second example of a gas valve assembly 70 (with housing 22 and cover 25 removed) is shown in FIGS. 4A and 4B. The gas valve assembly 70 is identical with gas valve assembly 60 of FIGS. 3A and 3B in all respects other than the thermal actuator. Gas valve assembly 70 includes a thermal actuator that comprises a bimetal member assembly 96. Bimetal member assembly 96 comprises a first bimetal member 98 and a second bimetal member 100. The first end 97 of the bimetal member assembly 96 is spaced apart from the second end 99 of the bimetal metal assembly 96 along the x-axis (FIG. 4B). First end 97 of first bimetal member 98 is also the first end 97 of the bimetal member assembly 96, and second end 99 of second bimetal member 100 is also the second end 99 of the bimetal member assembly 96. First bimetal member 98 is secured to the underside of insulator block 76 at first end 97 by rivet 69 in a cantilevered fashion with second end 105 of first bimetal member 98 being spaced apart from first end 97 of bimetal member 98 along the x-axis. Second end 105 of first bimetal member is attached to a first end 107 of second bimetal member 100 such that a portion of the first bimetal member 98 overlaps a portion of the second bimetal member along the x-axis. Second end 99 of second bimetal member 100 is attached to valve plug 72 by connector 67 as described previously with respect to FIGS. 3A and 3B.

In the case of FIGS. 4A and 4B, the orientations of the high and low coefficient of thermal expansion materials are reversed in first bimetal member 98 and second bimetal member 100 relative to one another. In first bimetal member 98, the low coefficient of thermal expansion material faces the ceramic heater 64 along the z-axis, and the high coefficient of thermal expansion material faces away from ceramic heater 64. However, in second bimetal member 100, the high coefficient of thermal expansion material faces toward the heater 64 in a direction along the z-axis whereas the low coefficient of thermal expansion material faces away from the ceramic heater 64 in a direction along the z-axis. This z-axis inversion of the high and low expansion alloys provides a means of decreasing the z-axis deflection of the valve plug 72 for a given length of the bimetal member assembly 96.

A simple cantilever element (such as bimetal member 66 of FIGS. 3A and 3B) that is subjected to a deflection temperature T₂ after being heated from and initial temperature T₁ deflects by and amount B along the z-axis at is free end in accordance to the following relationship:

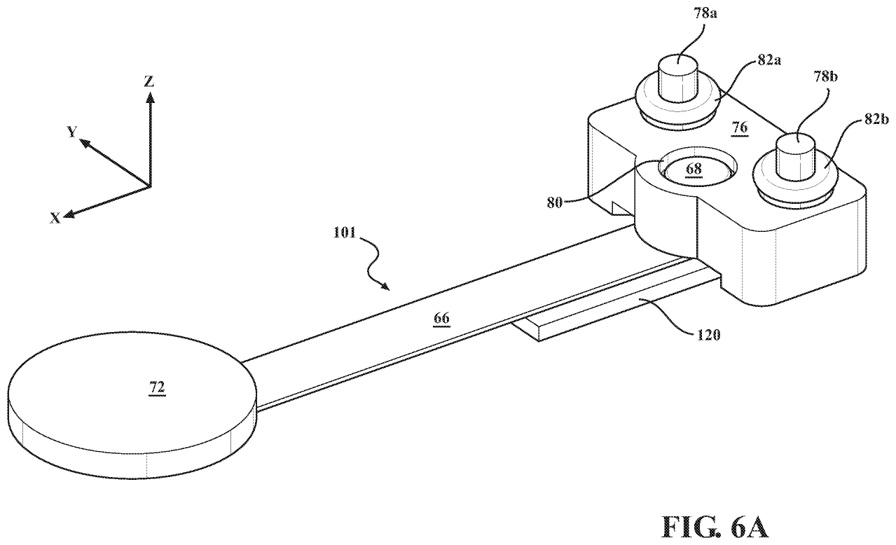

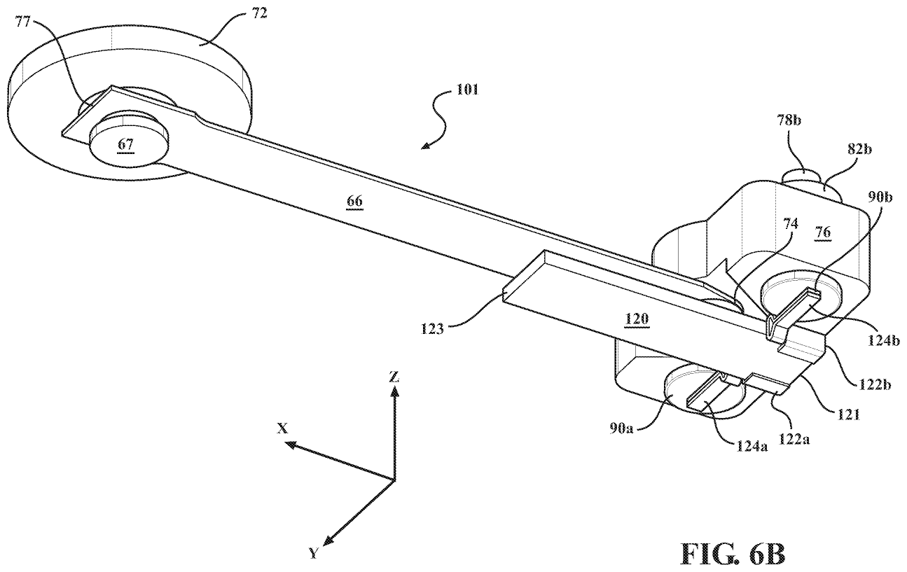

B=(0.53F(T₂−T₁)L²)/t (3)

wherein,
B=z-axis deflection of free end of a cantilevered member (in.)
T₂−T₁=temperature change (° F.);
L=Length of cantilevered member (in.);
F=flexivity ° F.⁻¹; and
t=z-axis thickness (in.)
   The z-axis deflection in the designs in FIGS. 3A-B and FIGS. 6A-B (discussed below) can be calculated using the above equation.

Referring to FIGS. 4A and 4B, it is also possible to design a reverse cantilever element in which the high coefficient of thermal expansion alloy of the first bimetal member 98 is oriented on top (facing cover 25 along the z-axis) and in the second bimetal member 100, the high coefficient of thermal expansion alloy is located on the bottom (facing away from cover 25 along the z-axis). The length of the first bimetal member 98 and the second bimetal member 100 do not need to be equal and the same is true for their respective thicknesses. The following relationship is used to describe a lap-welded cantilever element made of two different materials of different thicknesses and lengths.

B=0.53F(T₂−T₁)[(F_{b}b²)/t_{b}−(Fₐ(a²+2ab))/tₐ] (4)

wherein,
B=z-axis deflection of free end of a cantilevered member (in.)
T₂−T₁=temperature change (° F.)
Fₐ=Flexivity of first bimetal member 98
F_{b}=Flexivity of second bimetal member 100
tₐ=Thickness in inches of first bimetal member 98
t_{b}=Thickness in inches of second bimetal member 100
a=length in inches of first bimetal member 98 along x-axis; and
b=length in inches of second bimetal member 100 along x-axis.

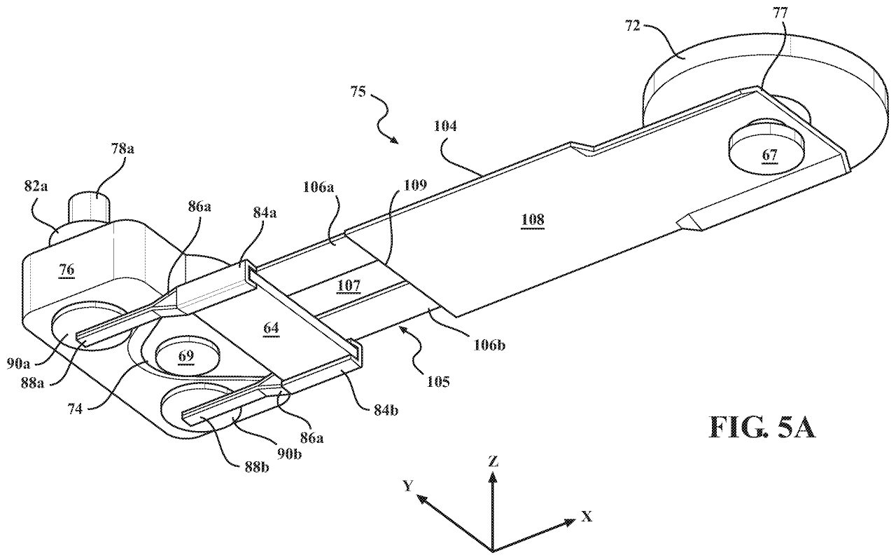

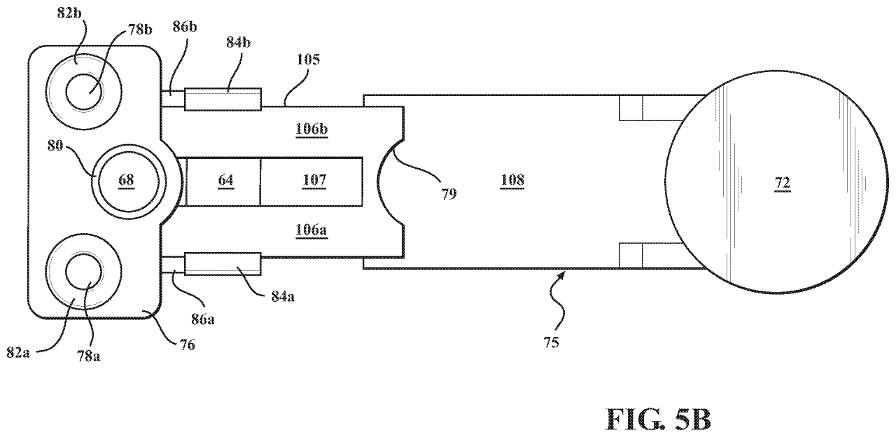

By varying the length and thickness of each bimetal member 98 and 100, the z-axis deflection (B) can be optimized by utilizing the above equation. The z-axis deflection in the designs of FIGS. 1A-D and FIGS. 4A-5B can be calculated using the above equation 2.

Referring to FIGS. 5A and 5B, a third example of a thermally-actuatable gas valve assembly 75 with the housing 22 and cover 25 removed is depicted. The thermally-actuatable gas valve assembly 75 differs from assemblies 60 and 70 in that it has a different thermal actuator but is the same in all other respects. The thermal actuator is a bimetal member assembly 104 comprising a first bimetal member 105 that is generally rectangular in shape, but which includes a cut-out 107. The cut-out 107 defines bimetal member sections 106a and 106b, each of which have a length along the x-axis and a width along y-axis, such that that the x-axis lengths of each member section 106a and 106b exceed their respective y-axis widths. Cut-out 107 reduces the thermal mass of first bimetal member 105 and improves the bimetal member assembly 104 response time. The x-axis lengths of bimetal member sections 106a and 106b are preferably equal as are the y-axis widths of each bimetal member section 106a and 106b. The proximal end 74 (FIG. 5A) of the first bimetal member 105 is also the proximal end of the bimetal member assembly 104 and is unitary (not split into multiple bimetal member sections). The proximal end 74 (FIG. 5A) of the bimetal member assembly is secured to the insulator block 76 using rivet 69, as described previously. The distal end 79 (FIG. 5A) of the first bimetal member 105 is also unitary and overlaps the proximal end 109 of the second bimetal member 108.

The second bimetal member 108 is unitary save for a distal end opening through which rivet 67 is disposed to secure the distal end 77 of the bimetal member assembly 104 to the valve plug 72. Each bimetal member 105 and 108 is preferably constructed of the same bimetal material as bimetal member 66 (FIGS. 3A-3B) and bimetal member assembly 96 (FIGS. 4A-4B).

In the exemplary gas valve assemblies 60, 70, and 75, the ceramic heater 64 is oriented with its length (longest dimension) orthogonal to the length (longest dimension) of bimetal member 66 or bimetal member assemblies 96, 104 such that the longest dimension of the ceramic heater 64 extends along the y-axis while the longest dimension of the bimetal member 66 or the bimetal member assemblies 96, 104 extends along the x-axis. One benefit of this arrangement is that the heater terminals 88a and 88b do not have to be bent to contact the rivets 90a and 90b. As shown in each of FIGS. 3A-3B, 4A-4B, and 5A-5B, connectors 84a and 84b have lengths along the x-axis, as do terminals 88a and 88b, wherein the lengths of connectors 84a and 84b are longer than their respective y-axis widths or z-axis thicknesses. While this arrangement is beneficial, others may also be used.

Referring to FIGS. 6A and 6B, gas valve assembly 101 is shown (with housing 22 and cover 25 removed). In FIGS. 6A and 6B gas valve assembly 101 differs from gas valve assembly 60 in FIG. 3B in that ceramic heater 120 is provided instead of ceramic heater 64. Ceramic heater 120 comprises the same ceramic materials and conductive ink described for ceramic heater 64. However, ceramic heater 120 has a length oriented along the x-axis, i.e., parallel to the length axis of the bimetal member 66. Ceramic heater 120 has a proximal end 121 (FIG. 6B) spaced apart from a distal end 123 along the x-axis. At proximal end 121, connectors 122a and 122b are brazed onto side edges of the ceramic heater 120 and are spaced apart from one another along the y-axis. Terminals 124a and 124b are respectively connected to a corresponding connector 122a and 122b and are oriented perpendicularly to the connectors 122a and 122b. Each terminal 124a and 124b is electrically connected to a corresponding rivet 90a and 90b to secure the bimetal member 66 to the insulator block 76. Ceramic heater 120 is preferably spaced apart from the bimetal member 66 along the z-axis so that the bimetal member 66 does not contact the ceramic heater 120 when the bimetal member 66 deflects to unseat valve plug 72 from gas outlet port 40 as well as when bimetal member 66 is in an undeflected condition. However, as opposed to the examples of FIGS. 3A-3B, 4A-4B, and 5A-5B, ceramic heater 120 extends along the x-axis to a location along the bimetal member 66 where some z-axis deflection will occur when placing the gas valve assembly outlet port 40 in fluid communication with the inlet port 38 (FIGS. 1A-1D). Thus, the ceramic heater is preferably spaced apart from bimetal member 66 along the z-axis to an extent that prevents the bimetal member 66 from damaging the ceramic heater 120 when deflecting.

A method of igniting gas will now be described with referenced to FIGS. 3A-3B. However, it is equally applicable to any of the gas valve assemblies of FIGS. 3A-6B. As indicated previously, it is assumed that the gas valve assembly includes the housing 22 and top 25 of FIGS. 1A-1D but has otherwise been modified as shown in FIGS. 3A-3B. In accordance with the method, a source of combustion gas is placed in selective fluid communication with a ceramic igniter (not shown). The source of combustion gas would be placed in selective fluid communication with the ceramic igniter, for example, by fluidly coupling the source of combustion gas to gas valve assembly inlet port 38 (FIG. 1A) and fluidly coupling the gas outlet port 40 to a burner with one or more gas orifices located proximate the ceramic igniter.

The ceramic igniter is energized such that it reaches a surface temperature of no less than an ignition temperature of the combustion gas, and the ceramic heater is energized, causing the bimetal member 66 to deflect and pull the valve plug 72 out of sealing engagement with the inlet 43 of the gas outlet port 40, at which point the gas outlet port 40 is in fluid communication with the interior 24 of the gas valve assembly (FIG. 1A) and the gas inlet port 38 (FIG. 1A) of the gas valve assembly. It is preferred that the ceramic igniter reach the combustion gas ignition temperature before the gas valve assembly 20 is placed in fluid communication with the igniter.

The ceramic igniter and ceramic heater are energized by placing them in series with a source of alternating current having an rms voltage of from 102V to 132V as shown in FIG. 2. Applying this source voltage to the circuit preferably applies a potential difference of at least about 75V, preferably at least 80V, and more preferably at least about 85V across the ceramic igniter and it also preferably applies a potential difference of at least about 12V, preferably at least about 15V, and more preferably at least about 20V across the ceramic heater. At the same time, the ceramic igniter power draw is preferably at least about 45 W, preferably at least about 50 W, and more preferably at least about 55 W while the ceramic heater power draw is preferably from about 7.5 W to less than about 20 W, preferably from about 10 W to less than about 20 W, and more preferably from about 15 W to less than about 20 W. At the same time to ensure that the valve plug 72 unseats from the gas outlet port 40, the ceramic heater power draw is preferably at least 8 W, preferably at least 8.5 W, and more preferably at least 9 W. At the foregoing values, the rms current supplied to the ceramic igniter and ceramic heater (which have the same current), is preferably from about 400 mA to about 700 mA, preferably from about 450 mA to about 650 mA, and more preferably from about 500 mA to about 600 mA. In one example, the method is carried out in an oven cavity.

As reflected in FIG. 2 and discussed previously, when placed in series with one another and a source of alternating current, the sum of—and the ratio of—the resistances of the ceramic heater 52, 64, 120 and the ceramic igniter 52 will dictate whether the ceramic igniter 52 reaches an ignition temperature and whether it does so in an acceptable time frame. The sum and ratio of the resistances will also determine whether the ceramic heater 52, 64, 120 reaches a deflection temperature of the bimetal member 66 or bimetal member assembly 96, 104 without overheating and damaging the bimetal member 66 or bimetal member assembly 96, 104. The effect of varying the igniter and heater resistances is illustrated in the following examples.

### EXAMPLES

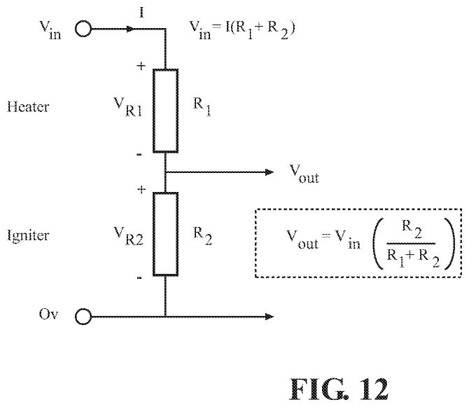

In the examples that follow, a ceramic heater is placed in series with a ceramic igniter and a source of alternating current as shown in FIG. 12. The input voltage to the ceramic heater is Vᵢₙ. The output voltage from the ceramic heater is represented as Vₒᵤₜ. Thus, the potential difference across the ceramic heater is Vᵢₙ−Vₒᵤₜ. The input voltage to the ceramic igniter is Vₒᵤₜ, and the output voltage from the ceramic igniter is zero (ground). R1 is the resistance of the ceramic heater, and R2 is the resistance of the ceramic igniter.

According to the Ohm's law, the rms input voltage to the ceramic heater can be related to the rms current to each of the ceramic heater and ceramic igniter as follows:

Vᵢₙ=I(R₁+R₂) (5)

where,
Vᵢₙ=ceramic heater rms input voltage (Volts);
I=rms current to ceramic heater and ceramic igniter (amps);
R₁=ceramic heater resistance (ohms); and
R₂=ceramic igniter resistance (ohms)

The input voltage to the ceramic heater and the output voltage from the ceramic heater (which is the input voltage to the ceramic igniter) may be related using the voltage divider equation, as follows:

Vₒᵤₜ=Vᵢₙ[R₂/(R₁+R₂)] (6)

### Example 1

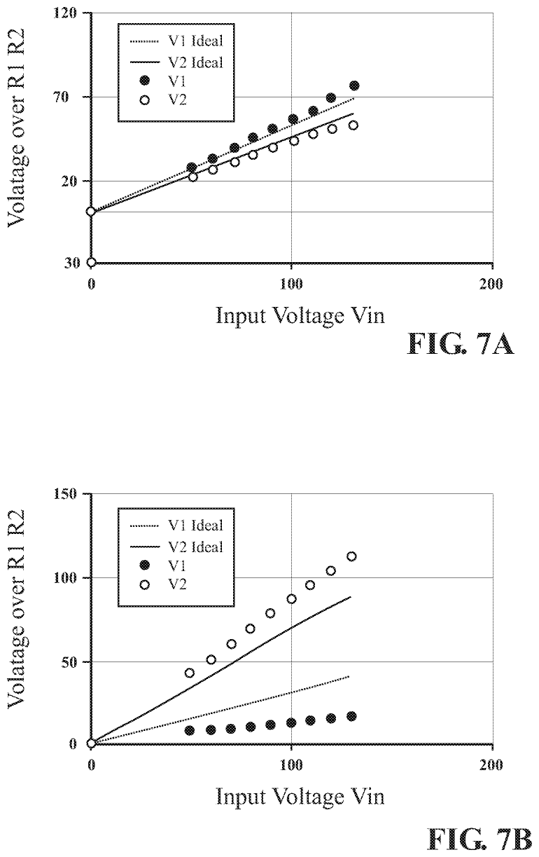

Referring to FIGS. 7A-7B, a ceramic heater having a room temperature resistance R1=42Ω is provided as are two ceramic igniters, one having a room temperature resistance of R2=34Ω, and the other having a room temperature resistance of 92Ω. Each igniter is separately placed in a circuit with the heater and a source of alternating current as shown in FIG. 12, and the input voltage from the AC source (Vᵢₙ) is varied. The ideal potential difference across the heater (Vᵢₙ−Vₒᵤₜ) is calculated from equation (3) and is also measured as is the potential difference across the igniter (Vₒᵤₜ−0=Vₒᵤₜ). The ceramic bodies for both the igniter and heater consist of 82 weight percent silicon nitride, 13 weight percent ytterbium oxide, and 5 weight percent molybdenum disilicide. The ink compositions are for both the ceramic igniter and the ceramic heater are 75 weight percent tungsten carbide, 20 weight percent silicon nitride, and two weight percent silicon carbide. The igniter and heater conductive ink thicknesses are varied to control the resistance to the specified values.

FIG. 7A shows the steady state potential difference across the ceramic heater and the ceramic igniter as predicted by equation (6)—and as measured—versus the input voltage Vᵢₙ for the case where R1=42Ω and R2=34Ω. The upper graph (“V1 Ideal”) and upper set of data points in FIG. 7A represent the potential difference across the ceramic heater (Vᵢₙ−Vₒᵤₜ). The lower graph (“V2 Ideal”) and lower set of data points in FIG. 7A represent the potential difference across the ceramic igniter (Vₒᵤₜ).

FIG. 7B shows the steady state potential difference across the ceramic heater and the ceramic igniter as predicted by equation (6)—and as measured—versus the input voltage Vᵢₙ for the case where R1=42Ω and R2=94Ω. The upper graph (“V2 Ideal”) and upper set of data points in FIG. 7A represent the steady state potential difference across the ceramic igniter (Vₒᵤₜ), whereas the lower graph (“V1 Ideal”) and lower set of data points represent the steady state potential difference across the ceramic heater (Vᵢₙ−Vₒᵤₜ). When the room temperature resistance of the ceramic igniter (R2) is significantly greater than the room temperature resistance of the ceramic heater (R1), the proportion of the total potential difference (Vᵢₙ) across the igniter relative to the heater increases with increasing input voltage Vᵢₙ. The deviation between the measured potential differences and those predicted by equation (6) is likely attributable to the fact that silicon nitride ceramic heaters and igniters have positive temperature coefficient of resistance, meaning the resistance increases with temperature. Thus, when the igniter has a significantly higher room temperature resistance (FIG. 7B), the igniter generates a proportionally higher amount of heat, thereby causing its resistance to increase at a faster rate than that of the ceramic heater. In contrast, when the room temperature resistances are similar in magnitude, the igniter and heater will heat at similar rates, causing their respective potential differences to more closely adhere to equation (6).

In the following examples, the ceramic igniter is used in an oven cavity and has a desired steady state temperature of from 2138° F. to 2700° F. at input rms voltages ranging from 102V rms AC to 130V rms AC. At the same time, the ceramic heater (R1 in FIG. 12) has a steady-state bimetal member deflection temperature of from about 200° F. to 1000° F. across the same range of input voltages Vᵢₙ. The minimum igniter power draw required to achieve the desired steady state temperature is at least 45 W. The maximum heater power draw to stay below the maximum bimetal member deflection temperature is no more than 20 W. To achieve the desired temperatures, the ratio of the room temperature resistance of the igniter R1 to that of the heater R2 is preferably from about 1.9 to about 4.0, more preferably from about 2.0 to about 3.8, and still more preferably from about 2.2 to about 3.6. At the same time, the sum of the room temperature resistances of the ceramic igniter and the ceramic heater is preferably from about 25Ω to about 60Ω, more preferably from about 30Ω to about 60Ω, and still more preferably from about 35Ω to about 55Ω.

### Example 2

A ceramic heater (FIG. 12) is provided and comprises two silicon nitride ceramic tiles with an embedded conductive ink circuit between the tiles. The room temperature resistivity of the conductive ink circuit is 1.1×10⁻⁴ Ω·cm, and the circuit is about 13 microns thick. The room temperature resistance is 14Ω. The conductive ink consists of 100 weight percent tungsten.

A ceramic igniter (FIG. 12) is provided and comprises two silicon nitride tiles with an embedded conductive ink circuit between the tiles. The room temperature resistivity of the conductive ink is 3.5×10⁻⁴ Ω·cm, and the circuit is about 25 microns thick. The conductive ink consists of 75 weight percent tungsten carbide, 20 weight percent silicon nitride, 3 weight percent ytterbium oxide, and 2 weight percent silicon nitride. The room temperature resistance R2 is 31Ω. The ceramic heater and igniter are placed in series with one another and a source of alternating current as shown in FIG. 12. The room temperature resistance ratio R2/R1 is 2.2, and the sum of the room temperature resistances R1+R2 is 45Ω.

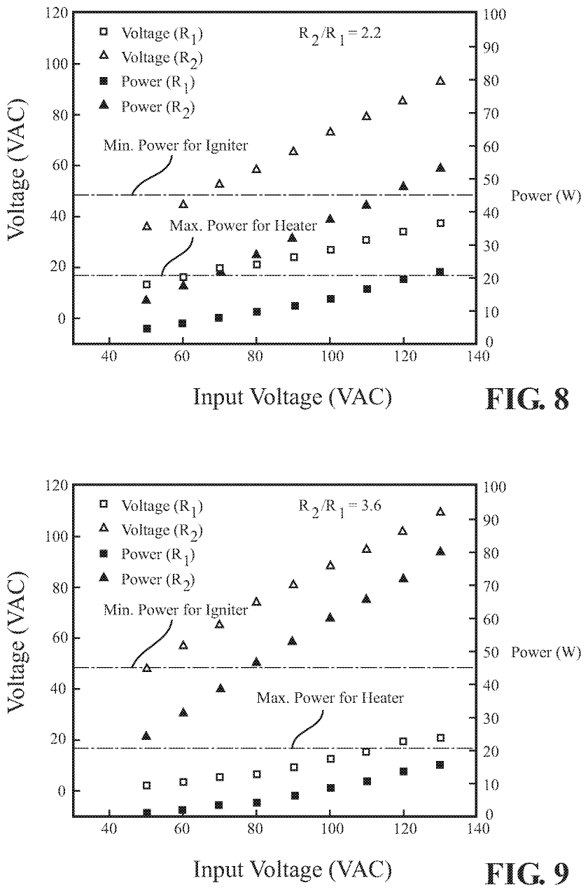

In this example and those that follow, the ceramic bodies for both the igniter and heater consist of 82 weight percent silicon nitride, 13 weight percent ytterbium oxide, and 5 weight percent molybdenum disilicide. Referring to FIG. 12, the input rms voltage (Vᵢₙ) is varied from 0 to 130 V rms. The resistances in ohms across the heater (R1) and igniter (R2) are measured, as are the potential differences in volts across the heater (V1) and igniter (V2). The rms current I (amps) is also measured and is the same for the igniter and heater. The heater power draw P1 (Watts) and igniter power draw P2 (Watts) are also determined. The results are shown in Table 1 and in FIG. 8:

TABLE 1

| Vᵢₙ | | | | | | | |
|---|---|---|---|---|---|---|---|
| (VAC) | R₂ | R₁ | V₂ | V₁ | I (A) | P₂ (W) | P₁(W) |
| 0 | 31 | 14 | 0 | 0 | 0 | 0 | 0 |
| 50 | 101.6111 | 37.27778 | 36.58 | 13.42 | 0.36 | 13.1688 | 4.8312 |
| 60 | 112.3737 | 39.14141 | 44.5 | 15.5 | 0.396 | 17.622 | 6.138 |
| 70 | 121.3256 | 41.46512 | 52.17 | 17.83 | 0.43 | 22.4331 | 7.6669 |
| 80 | 128.4061 | 46.26638 | 58.81 | 21.19 | 0.458 | 26.93498 | 9.70502 |
| 90 | 136.646 | 49.68944 | 66 | 24 | 0.483 | 31.878 | 11.592 |
| 100 | 143.5547 | 51.75781 | 73.5 | 26.5 | 0.512 | 37.632 | 13.568 |
| 110 | 148.8679 | 58.67925 | 78.9 | 31.1 | 0.53 | 41.817 | 16.483 |
| 120 | 154.3165 | 61.51079 | 85.8 | 34.2 | 0.556 | 47.7048 | 19.0152 |
| 130 | 162.6527 | 64.22339 | 93.2 | 36.8 | 0.573 | 53.4036 | 21.0864 |

In this case, the igniter power draw P2 at 100V rms is only about 38 W, less than what is needed to reach the desired steady state temperature. In addition, at 130V the heater power draw P2 is 21 W, which corresponds to an excessive bimetal member temperature of about 997° F. Thus, the combination of resistances R1 and R2 does not meet the requirements for the ceramic igniter and the thermally-actuated gas valve assembly.

### Example 3

A ceramic heater with a room temperature resistivity of 1.1×10⁻⁴ Ω·cm is provided. Its conductive ink circuit comprises 100 weight percent tungsten and has a thickness of 17 microns. The room temperature resistance R1 is 9Ω.

A ceramic igniter with a room temperature resistivity of 3.5×10⁻⁴ Ω·cm is provided. Its conductive ink circuit comprises 75 weight percent tungsten carbide, 20 weight percent silicon nitride, 3 weight percent ytterbium oxide, and 2 weight percent silicon carbide. The circuit is about 25 microns thick. The room temperature resistance R2 is 32Ω. The ceramic heater and ceramic igniter are placed in series with one another and with a source of alternating current as shown in FIG. 12. The input voltage Vᵢₙ is varied from 0 to 130V AC rms, and the power draws, current, voltages, and resistances are determined as in Example 2. The results are provided in Table 2 and in FIG. 9:

TABLE 2

| Vᵢₙ | | | | | | | |
|---|---|---|---|---|---|---|---|
| (VAC) | R₂ | R₁ | V₂ | V₁ | I (A) | P₂ (W) | P₁(W) |
| 0 | 32 | 9 | 0 | 0 | 0 | 0 | 0 |
| 50 | 97.95918367 | 4.081632653 | 48 | 2 | 0.49 | 23.52 | 0.98 |
| 60 | 103.6363636 | 5.454545455 | 57 | 3 | 0.55 | 31.35 | 1.65 |
| 70 | 110.1694915 | 8.474576271 | 65 | 5 | 0.59 | 38.35 | 2.95 |
| 80 | 117.4603175 | 9.523809524 | 74 | 6 | 0.63 | 46.62 | 3.78 |
| 90 | 124.6153846 | 13.84615385 | 81 | 9 | 0.65 | 52.65 | 5.85 |
| 100 | 129.4117647 | 17.64705882 | 88 | 12 | 0.68 | 59.84 | 8.16 |
| 110 | 137.6811594 | 21.73913043 | 95 | 15 | 0.69 | 65.55 | 10.35 |
| 120 | 142.2535211 | 26.76056338 | 101 | 19 | 0.71 | 71.71 | 13.49 |
| 130 | 149.5890411 | 28.49315068 | 109.2 | 20.8 | 0.73 | 79.716 | 15.184 |

From 100V to 130V AC rms the igniter power draw P2 exceeds 45 W, and the heater power draw P1 exceeds 8 W to allow gas to flow to the burner yet remains below 20 W to prevent the thermal actuator from overheating. Thus, the igniter has sufficient power to reach its desired ignition temperature while the heater does not exceed the maximum bimetal member deflection temperature. Thus, this combination of R1 and R2 in which the ratio of the room temperature resistances R2/R1 is 3.6 and the sum of the room temperature resistances R1+R2 is 41Ω achieves the desired igniter and thermally-actuated gas valve requirements.

### Example 4

A ceramic heater with a room temperature resistivity of 2.9×10⁻⁴ Ω·cm is provided. Its conductive ink circuit comprises 100 percent tungsten carbide and is about 17 microns thick. The room temperature resistance R1 is 25Ω.

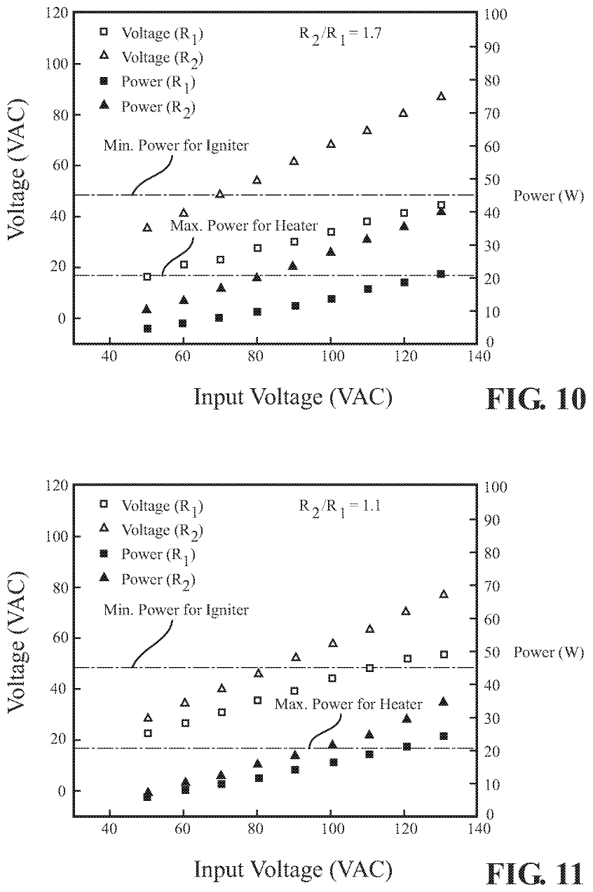

A ceramic igniter is provided with a room temperature resistivity of 3.5×10⁻⁴ Ω·cm. Its conductive ink circuit comprises 75 weight percent tungsten carbide, 20 weight percent silicon nitride, 3 weight percent ytterbium oxide, and 2 weight percent silicon carbide. The circuit is about 20 microns thick. The room temperature resistance R2 is 42Ω. The ratio of room temperature resistances R2/R1 is 1.7, and the sum of the room temperature resistances R1+R2 is 67Ω. The input voltage Vᵢₙ is varied from 0 to 130V AC rms, and the power draws, current, voltages, and resistances are determined as in Example 2. The results are provided in Table 3 and in FIG. 10:

TABLE 3

| Vᵢₙ | | | | | | | |
|---|---|---|---|---|---|---|---|
| (VAC) | R₂ | R₁ | V₂ | V₁ | I (A) | P₂ (W) | P₁(W) |
| 0 | 42 | 25 | 0 | 0 | 0 | 0 | 0 |
| 50 | 115.646259 | 54.4217687 | 34 | 16 | 0.294 | 9.996 | 4.704 |
| 60 | 126.837061 | 64.85623 | 39.7 | 20.3 | 0.313 | 12.4261 | 6.3539 |
| 70 | 139.411765 | 66.4705882 | 47.4 | 22.6 | 0.34 | 16.116 | 7.684 |
| 80 | 148.882682 | 74.5810056 | 53.3 | 26.7 | 0.358 | 19.0814 | 9.5586 |
| 90 | 158.115183 | 77.486911 | 60.4 | 29.6 | 0.382 | 23.0728 | 11.3072 |
| 100 | 166.75 | 83.25 | 66.7 | 33.3 | 0.4 | 26.68 | 13.32 |
| 110 | 172.857143 | 89.047619 | 72.6 | 37.4 | 0.42 | 30.492 | 15.708 |
| 120 | 180.821918 | 93.1506849 | 79.2 | 40.8 | 0.438 | 34.6896 | 17.8704 |
| 130 | 188.209607 | 95.6331878 | 86.2 | 43.8 | 0.458 | 39.4796 | 20.0604 |

While the heater does not exceed its maximum desired power draw of 20 W, even at a source voltage Vᵢₙ of 130V, the igniter fails to reach its minimum desired power draw of 45 W to reach its desired ignition temperature. This is due primarily to the high total resistance R1+R2 in the circuit. Thus, this combination of R1 and R2 does not meet the desired igniter and thermally-actuated gas valve criteria.

### Example 5

A ceramic heater with a room temperature resistivity of 2.8×10−⁴ Ω·cm is provided. Its conductive ink circuit comprises 84 weight percent tungsten carbide, 12 weight percent silicon nitride, 3 weight percent ytterbium oxide, and 2 weight percent silicon carbide. The circuit is about 17 microns thick. The room temperature resistance R1 is 37Ω.

A ceramic igniter is provided with a room temperature resistivity of 3.5×10⁻⁴ Ω·cm. The conductive ink circuit comprises 75 weight percent tungsten carbide, 20 weight percent silicon nitride, 3 weight percent ytterbium oxide, and 2 weight percent silicon carbide. The circuit is about 20 microns thick. The room temperature resistance R2 is 42Ω. The ratio of room temperature resistances R2/R1 is 1.1, and the sum of the room temperature resistances R1+R2 is 79Ω.

The input voltage Vᵢₙ is varied from 0 to 130V AC rms, and the power draws, current, voltages, and resistances are determined as in Example 2. The results are provided in Table 4 and in FIG. 11:

TABLE 4

| Vᵢₙ | | | | | | | |
|---|---|---|---|---|---|---|---|
| (VAC) | R₂ | R₁ | V₂ | V₁ | I (A) | P₂ (W) | P₁(W) |
| 0 | 42 | 37 | 0 | 0 | 0 | 0 | 0 |
| 50 | 112.0481928 | 88.75502008 | 27.9 | 22.1 | 0.249 | 6.9471 | 5.5029 |
| 60 | 121.1870504 | 94.64028777 | 33.69 | 26.31 | 0.278 | 9.36582 | 7.31418 |
| 70 | 130.6622517 | 101.1258278 | 39.46 | 30.54 | 0.302 | 11.91692 | 9.22308 |
| 80 | 139.3846154 | 106.7692308 | 45.3 | 34.7 | 0.325 | 14.7225 | 11.2775 |
| 90 | 146.7048711 | 111.1747851 | 51.2 | 38.8 | 0.349 | 17.8688 | 13.5412 |
| 100 | 153.8043478 | 117.9347826 | 56.6 | 43.4 | 0.368 | 20.8288 | 15.9712 |
| 110 | 163.0208333 | 123.4375 | 62.6 | 47.4 | 0.384 | 24.0384 | 18.2016 |
| 120 | 168.6893204 | 122.5728155 | 69.5 | 50.5 | 0.412 | 28.634 | 20.806 |
| 130 | 176.201373 | 121.2814645 | 77 | 53 | 0.437 | 33.649 | 23.161 |

The igniter power draw P2 is too low to meet the igniter's ignition requirements across the range of input voltages (Vᵢₙ) from 102V to 130V AC rms. In addition, the heater power draw is too high at and above 120V AC rms and would result in a temperature exceeding the bimetal member's maximum deflection temperature. Thus, this combination of resistances R1 and R2 does not meet the requirements of the ceramic igniter or the thermally-actuated gas valve.

The foregoing examples show that a room temperature resistance ratio R2/R1 of 3.6 and room temperature total resistance R1+R2 of 41Ω achieves the desired igniter and thermally-actuated gas valve performance. A ratio R2/R1 of 2.2 at a total resistance of 45Ω was not sufficient. However, if the thermal actuator of Example 2 were made from a bimetal member with a maximum deflection temperature of more than 1000° F., the ratio of 2.2 at a total resistance of 45Ω may be satisfactory.

What is claimed is:

1. A thermally-actuated gas valve assembly, comprising:
a housing having a gas inlet, a gas outlet, and an interior volume that is in selective fluid communication with the gas outlet;
a thermal actuator disposed in the interior volume;
a valve plug operatively connected to the thermal actuator and positioned to selectively seal the gas outlet from the interior volume; and
a ceramic heater, wherein the ceramic heater is in thermal communication with the thermal actuator.

2. The thermally-actuated gas valve assembly of claim 1, wherein the ceramic heater comprises a ceramic body and a conductive ink pattern disposed in the ceramic body.

3. The thermally-actuated gas valve assembly of claim 2, wherein the ceramic body comprises silicon nitride.

4. The thermally-actuated gas valve assembly of claim 1, wherein the ceramic heater has a conductive ink circuit having a positive temperature coefficient of resistivity.

5. The thermally-actuated gas valve assembly of claim 1, wherein the thermal actuator comprises at least one bimetallic member that is thermally deflectable to selectively position the valve plug in and out of sealing engagement with the gas outlet.

6. The thermally-actuated gas valve assembly of claim 1, wherein the thermal actuator comprises a bimetallic member with a first end fixed in location within the interior of the housing and a second free end spaced apart from the first end along a length axis of the bimetallic member, and wherein the valve plug is connected to the second free end of the bimetallic member such that when the bimetallic member is subjected to a deflection temperature, the second end of the bimetallic member moves the valve plug out of sealing engagement with the gas outlet.

7. The thermally-actuated gas valve assembly of claim 6, wherein the deflection temperature is from about 150° F. to about 1,000° F.

8. The thermally-actuated gas valve assembly of claim 6, wherein the bimetallic member has a flexivity measured in accordance with ASTM D 388-06 of from about 7.0×10⁻⁶° F.⁻¹ to about 11.0×10⁻⁶° F.⁻¹.

9. The thermally-actuated gas valve assembly of claim 1, wherein the ceramic heater has a conductive ink pattern with a room temperature resistance of from about 5 ohms to about 15 ohms.

10. The thermally-actuated gas valve assembly of claim 9, wherein over a temperature range of from 2138° F. to 2700° F., the conductive ink pattern has a high temperature resistance of from 17Ω to 28Ω.

11. The thermally-actuated gas valve assembly of claim 9, wherein the conductive ink pattern has a room temperature resistivity of from about 6.5×10⁻⁵ Ω·cm to about 2×10⁻⁴ Ω·cm.

12. The thermally-actuated gas valve assembly of claim 1, wherein ceramic heater comprises a conductive ink pattern, and the conductive ink comprises silicon nitride in an amount no more than about 30 percent by weight of the conductive ink and at least one conductive component in an amount no less than about 70 percent by weight of the conductive ink, wherein the at least one conductive component is selected from the group consisting of tungsten, tungsten carbide, manganese, molybdenum disilicide, alumina, and silica.

13. The thermally-actuated gas valve assembly of claim 12, wherein the conductive ink comprises no more than about six percent by weight of sintering aids selected from the group consisting of oxides, metals, and rare earth oxides.

14. The thermally-actuated gas valve assembly of claim 1, wherein the ceramic heater has a length along a length axis of from about 0.4 to about 1.0 inch, a width along a width axis of from about 0.15 to about 0.35 inches, a thickness along a thickness axis of from about 0.03 inches to about 0.08 inches, the length is greater than the width, and the width is greater than the thickness.

15. The thermally-actuated gas valve assembly of claim 1, wherein the ceramic heater has a length along a length axis, a width a long a width axis, a thickness along a thickness axis, and a conductive ink pattern having a pre-firing thickness along the thickness axis of not less than about 0.0002 inches and not more than about 0.003 inches.

16. A gas heating system, comprising:
the thermally-actuated gas valve assembly of claim 1; and
a ceramic igniter in fluid communication with the gas outlet, wherein the ceramic igniter and the ceramic heater are selectively connected to a source of alternating current and are in series with respect to one another.

17. The gas heating system of claim 16, wherein the ceramic igniter has a room temperature resistance, the ceramic heater has a room temperature resistance, and a ratio of the ceramic igniter room temperature resistance to the ceramic heater room temperature resistance is from about 1.9 to about 4.0.

18. The gas heating system of claim 16, wherein the ceramic igniter has a high temperature resistance, the ceramic heater has a high temperature resistance, and over a temperature range from 2138° F. to 2700° F. a ratio of the ceramic igniter high temperature resistance to the ceramic heater high temperature resistance is from about 1.9 to about 8.0

19. The gas heating system of claim 16, wherein the ceramic igniter has a room temperature resistance of from about 20 ohms to about 60 ohms.

20. The gas heating system of claim 17, wherein the ceramic igniter has a room temperature resistance, the ceramic heater has a room temperature resistance, and the sum of the ceramic igniter room temperature resistance and the ceramic heater room temperature resistance is from about 25 ohms to about 65 ohms.

21. The gas heating system of claim 20, wherein the ceramic igniter has a high temperature resistance, the ceramic heater has a high temperature resistance, and over the temperature range of from 2138° F. to 2700° F., the sum of the high temperature resistance of the ceramic heater and the high temperature resistance of the ceramic igniter is from about 145Ω to about 288Ω.

22. The gas heating system of claim 16, wherein the ceramic igniter has a ceramic body with a length defining a length axis, a width defining a width axis, and a thickness defining a thickness axis, the ceramic igniter comprising:
first and second ceramic tiles having respective outer surfaces;
a conductive ink pattern disposed between the first and second ceramic tiles, wherein the igniter has a thickness along the thickness axis of from about 0.047 to about 0.060 inches and when subjected to a potential difference of 120 V AC rms, at least one of the respective igniter outer surfaces reaches a temperature of at least 1400° F. in no more than 8 seconds.

23. The gas heating system of claim 22 wherein the ceramic igniter conductive ink has a thickness along the thickness axis of from about 0.0004 inches to about 0.002 inches.

24. The gas heating system of claim 22 wherein the conductive ink comprising the conductive ink pattern of the ceramic igniter comprises silicon nitride and tungsten carbide.

25. The gas heating system of claim 16, wherein the ceramic igniter comprises a conductive ink pattern having a positive temperature coefficient of resistivity.

26. The gas heating system of claim 25, wherein the ceramic heater comprises a conductive ink pattern having a positive temperature coefficient of resistivity.

27. A gas heating system, comprising:
a ceramic igniter comprising a conductive ink pattern having a positive temperature coefficient of resistivity;
a thermally-actuated gas valve assembly comprising: i) a housing having a gas inlet, a gas outlet, and an interior volume that is in selective fluid communication with the gas outlet; (ii) a thermal actuator disposed in the interior volume; (iii) a valve plug operatively connected to the thermal actuator and positioned to selectively seal the gas outlet from the interior volume; and (iv) a heater in thermal communication with the thermal actuator.

28. The gas heating system of claim 27, wherein the heater is a ceramic heater comprising a conductive ink pattern.

29. The gas heating system of claim 28, wherein the ceramic heater conductive ink pattern has a positive temperature coefficient of resistivity.

30. A method of igniting gas, comprising:
providing a source of combustion gas in selective fluid communication with a ceramic igniter;
providing a gas valve assembly comprising a thermal actuator and a ceramic heater in thermal communication with the thermal actuator, wherein the gas valve assembly is operable to selectively place the source of combustion gas in fluid communication with the ceramic igniter;
energizing the ceramic igniter such that the ceramic igniter reaches a surface temperature of no less than an ignition temperature of the combustion gas;
energizing the ceramic heater to place the source of combustion gas in fluid communication with the ceramic igniter.

31. The method of claim 30, wherein the thermal actuator comprises a deflectable member, and the step of energizing the ceramic heater to place the source of combustion gas in fluid communication with the ceramic igniter comprises heating the thermal actuator such that it deflects.

32. The method of claim 30, wherein the ceramic igniter has a room temperature resistance, the ceramic heater has a room temperature resistance, and the ratio of the ceramic igniter room temperature resistance to the ceramic heater room temperature resistance is from about 1.9Ω to about 4.0 Ω.

33. The method of claim 30, wherein the ceramic heater has a high temperature resistance and wherein over a temperature range of from 2138° F. to 2700° F., the ceramic heater high temperature resistance is from about 17Ω to about 28 Ω.

34. The method of claim 30, wherein the ceramic igniter has a high temperature resistance, the ceramic heater has a high temperature resistance, and wherein over a temperature range from 2138° F. to 2700° F., the ratio of the ceramic igniter high temperature resistance to the ceramic heater high temperature resistance is from about 1.9 to about 8.0.

35. The method of claim 30, wherein the ceramic igniter has a room temperature resistance of from about 20 ohms to about 60 ohms.

36. The method of claim 30, wherein over a temperature range from 2138° F. to 2700° F., the ceramic igniter has a high temperature resistance of from about 115Ω to about 280Ω.

37. The method of claim 30, wherein ceramic igniter has a room temperature resistance, the ceramic heater has a room temperature resistance, and the sum of the ceramic igniter room temperature resistance and the ceramic heater room temperature resistance is from about 25 ohms to about 65 ohms.

38. The method of claim 30, wherein the ceramic igniter has a high temperature resistance, the ceramic heater has a high temperature resistance, and over a temperature range of from 2138° F. to 2700° F., the sum of the high temperature resistance of the ceramic heater and the high temperature resistance of the ceramic igniter is from about 145Ω to about 288Ω.

39. The method of claim 30, wherein the gas valve assembly comprises a gas inlet and a gas outlet, the thermal actuator is fixed at one end relative to a ceramic insulator in the gas valve assembly and has a free second end connected to a valve plug, the valve plug is removably seated in the gas outlet, such that when the thermal actuator deflects the valve plug becomes unseated from the gas outlet to place the gas inlet in fluid communication with the gas outlet.

40. The method of claim 39, wherein the gas inlet is placed in fluid communication with the gas outlet no sooner than when the ceramic igniter reaches an ignition temperature of the combustion gas.

41. The method of claim 30, wherein the ceramic igniter and the ceramic heater are in series with one another and with a source of alternating current.

42. The method of claim 41, wherein the source of alternating current has an rms voltage of from about 102V AC to about 132 V AC.

43. The method of claim 30, wherein the step of energizing the ceramic igniter comprises energizing the ceramic igniter such that a surface temperature of the ceramic igniter reaches an ignition temperature of the combustion gas in no less than about eight seconds.

44. The method of claim 43, wherein the ignition temperature is no less than about 1400° F.

45. The method of claim 30, wherein the thermal actuator comprises a bimetal member having a length along a first axis and a width along a second axis, and the ceramic heater comprises a body having a length along the second axis and a width along the first axis.
